(19) United States
(12) Patent Application Publication
(10) Pub. No.: US 2025/0291873 A1
(43) Pub. Date: Sep. 18, 2025

(54) Universal Scale Metadata Layout for Matrix Multiply and Add (MMA)

(71) Applicant: NVDIA Corporation, Santa Clara, CA (US)

(72) Inventors: Maciej Tyrlik, Santa Clara, CA (US); Andreas Sembrant, Santa Clara, CA (US); Ajay Tirumala, Santa Clara, CA (US); Daniel Stiffler, Santa Clara, CA (US); Manan Patel, Santa Clara, CA (US)

(21) Appl. No.: 18/606,691

(22) Filed: Mar. 15, 2024

(51) Int. Cl. G06F 17/16

(52) U.S. Cl. CPC G06F 17/16

(57) ABSTRACT

This disclosure describes efficiently performing matrix multiply and add (MMA) operations using narrow operands. Narrow operand size (e.g., 8 bit/6 bit/4 bit operand) MMA operations utilize scale metadata in order to improve accuracy of the MMA operation. An efficient layout for scale metadata in narrow operand size MMA operations and its use are described. The proposed layout provides for efficient storing and efficient use of scale metadata.

### CROSS REFERENCE TO RELATED APPLICATIONS

This application is related to the following applications:
U.S. patent application Ser. No. 18/449,381 titled “Method and Apparatus for Direct Convolution Calculation” and filed Aug. 14, 2023;
U.S. patent application Ser. No. 18/458,638 titled “Method and Apparatus for Weight-Stationary Direct Convolution Calculation” and filed Aug. 14, 2023; and
U.S. patent application Ser. No. 18/484,790 titled “Low Precision Floating-Point Datapath in a Computer Processor” filed Oct. 11, 2023.

The entire content of each of the above applications is herein incorporated by reference.

### FIELD

This technology generally relates to parallel processing systems. More particularly, the technology herein relates to the organization and movement of data for matrix multiply and add (MMA) circuitry in such processing systems.

### BACKGROUND

Matrix multiply and add (MMA) is frequently performed in numerous high-demand applications. For example, deep learning and machine learning applications for tasks such as image/video processing, natural language processing, etc., scientific computing applications for tasks such as 3D simulations, signal processing, etc., and graphics and video editing applications for tasks such as ray tracing, video editing and processing, etc., may make heavy use of highly efficient MMA capabilities of parallel processing systems such as graphics processing units (GPU).

As processing capabilities improve and application demands increase, the energy consumption of computing platforms increases. The large number of processors deployed in modern graphics processing units (GPUs) for high demand applications, for example, makes it desirable to reduce energy requirements of such processors.

The design and operation of the data path, which sits at the core of a processor, contributes a significant portion of the total energy consumption of the processor, and may be a particularly significant contributor in GPUs executing applications such as deep learning workloads that use a large number of data paths in parallel. One mechanism to improve the energy efficiency of data paths is the utilization of lower precision and alternative data formats (e.g., Integer e.g., INT8, Floating-point, Log, VS-Quant). Such lower precision and alternative data formats may allow for narrower operand sizes that can reduce energy consumption.

The use of narrow operand sizes on the data path, due to the lower precision of narrow operand sizes, may require making additional data (e.g., scaling information) to be made available for calculations. For large matrices being subjected to an MMA operation, this additional data can itself be large, and its movement through the memory hierarchy of a GPU can be inefficient. Therefore, in order to more fully benefit from the reduced energy consumption of narrow operand sizes, it is desirable to improve the organization and movement of additional data that is required for processing narrow operands.

### BRIEF DESCRIPTION OF THE DRAWINGS

FIG. 1 conceptually illustrates an MMA operation between an A matrix and a B matrix using scale factors, in accordance with some embodiments of the present disclosure.

FIG. 2A schematically illustrates examples of a scale metadata block data structure, according to some embodiments of the present disclosure.

FIG. 2B schematically illustrates examples of the scale metadata block arrangement in different levels of the memory hierarchy in a computer system, in accordance with some embodiments of the present disclosure.

FIG. 2C schematically illustrates an example area on A or B matrix mapped by a scale metadata block, a depth vector mapped to the A or B matrix, and a scale metadata vector, in accordance with some embodiments of the present disclosure.

FIG. 3 shows examples of the logical organization of scale metadata blocks corresponding to different sizes of operand matrices, in accordance with some embodiments of the present disclosure.

FIG. 4A shows an example mapping of scale factors in a scale metadata block mapped to the A matrix, FIG. 4B shows a mapping to the B matrix, and FIG. 4C shows a mapping to A or B matrices, according to some embodiments of the present disclosure.

FIG. 5 illustrates a flowchart of a process to calculate a product of an A matrix and a B matrix based on operands of the A and B matrices and scale metadata associated with the operands.

FIG. 6 shows an example micro-architecture for the data path of an example MMA circuitry, in accordance with some embodiments of the present disclosure.

FIG. 7A and FIG. 7B illustrate a portion of a processor (a data path processor) that includes a data path configured to implement MMA operations according to some embodiments.

FIG. 8 illustrates an example parallel processing unit (PPU), according to some embodiments.

FIG. 9A illustrates an example general processing cluster (GPC) within the parallel processing unit of FIG. 8, according to some embodiments.

FIG. 9B illustrates an example memory partition unit of the parallel processing unit of FIG. 8.

FIG. 10A illustrates an example streaming multiprocessor (SM) of FIG. 9A with MMA circuitry, according to some embodiments.

FIG. 10B conceptually illustrates four subpartitions implemented in an SM such as the SM shown in FIG. 10A, according to some embodiments.

FIG. 11A is an example conceptual diagram of a processing system implemented using the PPU of FIG. 8.

FIG. 11B is a block diagram of an exemplary system in which the various architecture and/or functionality of the various previous embodiments may be implemented.

### DETAILED DESCRIPTION OF EXAMPLE NON-LIMITING EMBODIMENTS

As noted above, the use of narrow operand sizes in the data path can reduce energy consumption, but may require additional data to be provided to the processors for use in calculations such as, for example, matrix multiplication of two matrices. The additional data may include scaling data to scale the narrow operands. Embodiments of the present disclosure provide data layouts of scale metadata (e.g., scale factors that can be applied to the matrices of operands) that can be efficiently used by the data paths in a processor for matrix multiply and add (MMA) operations. The layouts can significantly reduce or eliminate additional data manipulations of the scale metadata as it is moved among the multiple levels of the memory hierarchy in the processor. In particular, the data layouts disclosed herein provide for improved energy efficiency in MMA calculations performed using narrow operand sizes.

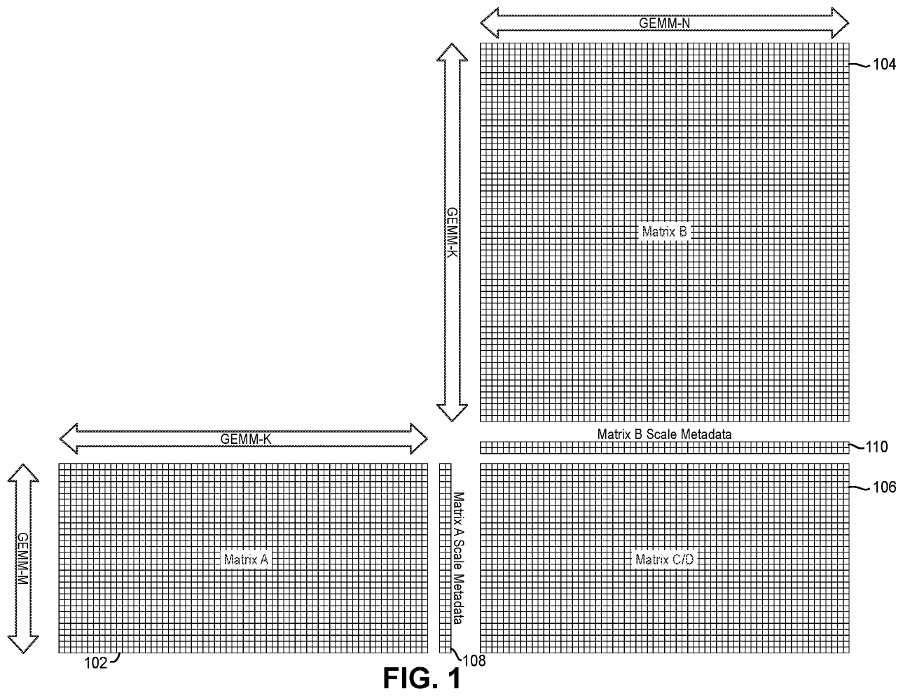

FIG. 1 conceptually illustrates an MMA operation between Matrix A (“A matrix”) 102 and Matrix B (“B matrix”) 104, used in the description below. Matrix A 102 comprises M rows and K columns. Matrix B 104 comprises K rows and N columns. The dot product of matrices A and B (102 and 104) is accumulated in Matrix C 106. The output of the MMA calculation is the final Matrix C, represented as Matrix D (also shown as 106).

One mechanism for narrow operand sizes as mentioned above is utilization of 8-bit floating-point formats (FP8) that provide higher accuracy than the 8-bit integer (INT8) formats. However, the higher accuracy of FP8 comes at the cost of lower energy efficiency than Int8. U.S. application Ser. No. 18/484,790, titled “LOW-PRECISION FLOATING-POINT DATAPATH IN A COMPUTER PROCESSOR” and filed Oct. 11, 2023, by NVIDIA CORPORATION (hereinafter referred to as “NARROW FP APPLICATION”), herein incorporated by reference in its entirety, discloses mechanisms that utilize a multiplier unit configured to multiply two low precision floating-point (FP) operands to generate an integer formatted (INT) result, and an adder configured to add the integer result to a third operand. It also discloses utilizing multiplier units configured to multiply two low-precision (e.g., FP4) VS-Quant floating-point operands to generate a first INT result, an adder to reduce the first INT results to a second INT result, and logic to multiply the second INT result by a low-precision floating-point scale factor. The NARROW FP APPLICATION also describes utilizing a multiplier unit configured to add two low-precision VS-Quant (e.g., LOG4) floating-point operands into a first sum, logic to convert a portion of the first sum into an INT result, and logic to convert the INT result to an INT product of the floating-point operands. Herein, “low precision floating-point” refers to floating-point data formats utilizing 8 or fewer bits (e.g., 4/6/8).

The mechanisms described in the NARROW FP APPLICATION utilize energy-efficient floating-point data path microarchitectures with integer accumulation, and enhanced mechanisms for per-vector scaled quantization (VS-Quant) of low-precision floating-point arguments. Herein, “FP” refers to floating point data formats, INT refers to integer data formats, and INT32 refers to the well-known 32-bit fixed point representation of integer data types. Example FP8 floating point data formats that can be utilized in example embodiments herein comprise two encodings—E4M3 and E5M2, where the name encodes the number of exponent (E) and mantissa (M) bits. For this data format, the term “mantissa” refers to IEEE 754 standard's trailing significand field (i.e. bits not including the implied leading 1 bit for normal floating point numbers).

Thus, when using narrow operand size for calculating the MMA of A and B matrices (e.g., activations matrix and weights matrix, respectively, in some applications) the elements of the A and B matrices, that are represented using narrow operand sizes, may be multiplied by scale factors so that the calculation can take advantage of an entire desired range (e.g., entire inferencing range). The scale factors are stored separately from the A and B matrix operands, and are made available to the MMA circuitry separately.

In FIG. 1, the matrix 108 contains the scale factors for the A matrix 102, and matrix 110 contains the scale factors for the B matrix 104. When scale factors are used, the dot product of the A and B matrices is further multiplied by the corresponding scale factors. The scale factors are referred to herein as “scale metadata.”

The scale metadata, or scale factors, for matrix A are provided as one or more scale factors per row of A. Similarly, the scale metadata, or scale factors, for matrix B are provided as one or more scale factors per column of B. In some embodiments, one scale factor is provided for an entire row of operands of the A matrix or an entire column of operands of the B matrix. In some embodiments, each vector of a “scale metadata vector length” along a row (i.e., in the K direction) of operands of the A matrix or the column (i.e., in the K direction) of operands in the B matrix may be multiplied by a respective scale factor. The scale metadata vector length defines the number of operands in the row of the A matrix or the column of the B matrix that is multiplied by each scale factor. Dividing the data path depth by the scale metadata vector length yields the number of scale factors specified per vector, of which the length is equal to the data path depth, in a row of A or column of B.

Narrow operand size (e.g., 8 bit/6 bit/4 bit operand) MMA operations utilize scale metadata in order to improve the accuracy of MMA operations. Whereas traditional MMA operation can be defined as C_{x,y}=(sum from k=1 to “data path depth” of A_{x,k}*B_{k,y})+C_{x,y}, the MMA operation with the use of scale metadata can be defined as C_{x,y}=((sum from k=1 to “data path depth” of A_{x,k}*B_{k,y})*(product from v=1 to “number of scale metadata values” scale Aᵥ*scale Bᵥ))+C_{x,y}. As noted above, multiple scale metadata values can be used per data path depth of A or B matrix elements.

For example, when 2 scale metadata values are used per data path depth (i.e., herein the “X2” format) the result matrix of the MMA of A and B matrices can be determined as (Equation 1):

$$D [ m ] [ n ] = ( A [ m ] [ 0 ] ⋆ B [ 0 ] [ n ] + … + A [ m ] [ k / 2 - 1 ] ⋆ B [ k / 21 ] [ n ] ) ⋆ SF\_A [ m ] [ 0 ] * SF\_B [ n ] [ 0 ] + ( A [ m ] [ k / 2 ] ⋆ B [ k / 2 ] [ n ] + … + A [ m ] [ k ] ⋆ B [ k ] [ n ] ) ⋆ SF\_A [ m ] [ 1 ] ⋆ SF\_B [ n ] [ 1 ] + C [ m ] [ n ] .$$

When 4 scale metadata values are used per data path depth (i.e., herein the “X4” format), the result matrix of the MMA of A and B matrices can be determined as (Equation 2):

$$D [ m ] [ n ] = ( A [ m ] [ 0 ] ⋆ B [ 0 ] [ n ] + … + A [ m ] [ k / 41 ] ⋆ B [ k / 41 ] [ n ] ) ⋆ SF\_A [ m ] [ 0 ] ⋆ SF\_B [ n ] [ 0 ] + ( A [ m ] [ k / 4 ] ⋆ B [ k / 4 ] [ n ] + … + A [ m ] [ k / 2 - 1 ] ⋆ B [ k / 2 - 1 ] [ n ] ) ⋆ SF\_A [ m ] [ 1 ] * SF\_B [ n ] [ 1 ] + ( A [ m ] [ k / 2 ] ⋆ B [ k / 2 ] [ n ] + … + A [ m ] [ 3 k / 4 - 1 ] ⋆ B [ 3 k / 4 - 1 ] [ n ] ) ⋆ SF\_A [ m ] [ 2 ] ⋆ SF\_B [ n ] [ 2 ] + ( A [ m ] [ 3 k / 4 ] ⋆ B [ 3 k / 4 ] [ n ] + … + A [ m ] [ k ] ⋆ B [ k ] [ n ] ) ⋆ SF\_A [ m ] [ 3 ] ⋆ SF\_B [ n ] [ 3 ] + C [ m ] [ n ] .$$

In the above equations, A[ ][ ] and B[ ][ ] are operands from operand matrices, and SF_A[ ] and SF_B[ ] are scale factors.

Table 1 below illustrates example associations between the number of scale factors per data path depth and the scale metadata vector size for some example data path sizes, according to some embodiments:

| | Number of scale | |
|---|---|---|
| | factors per data | Scale metadata |
| Data path depth | path depth | vector size |
| 96 | 4 (X4) | 24 |
| 96 | 2 (X2) | 48 |
| 96 | 1 (X1) | 96 |
| 64 | 4 (X4) | 16 |
| 64 | 2 (X2) | 32 |
| 64 | 1 (X1) | 64 |
| 48 | 4 (X4) | 12 |
| 48 | 2 (X2) | 24 |
| 48 | 1 (X1) | 48 |
| 32 | 4 (X4) | 8 |
| 32 | 2 (X2) | 16 |
| 32 | 1 (X1) | 32 |

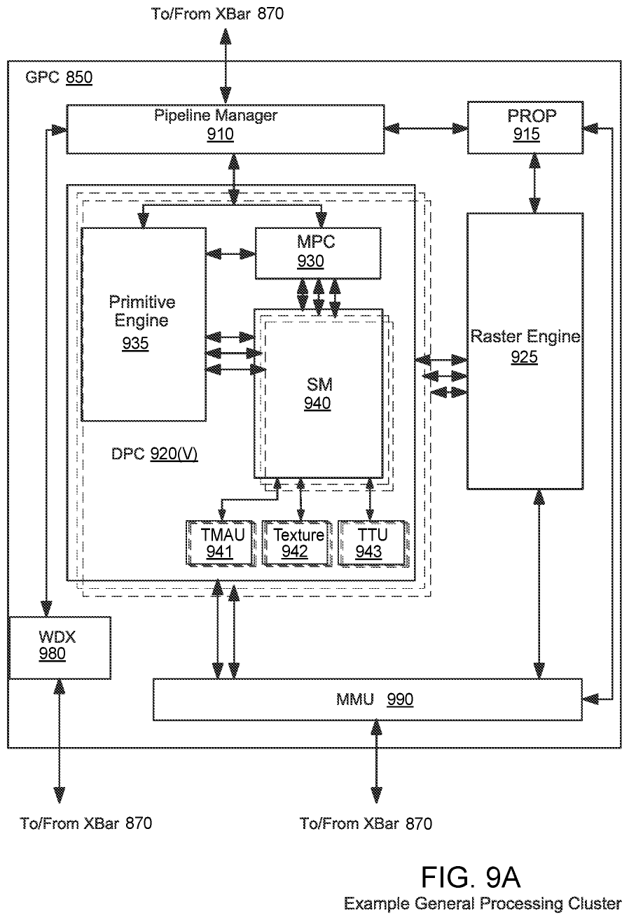

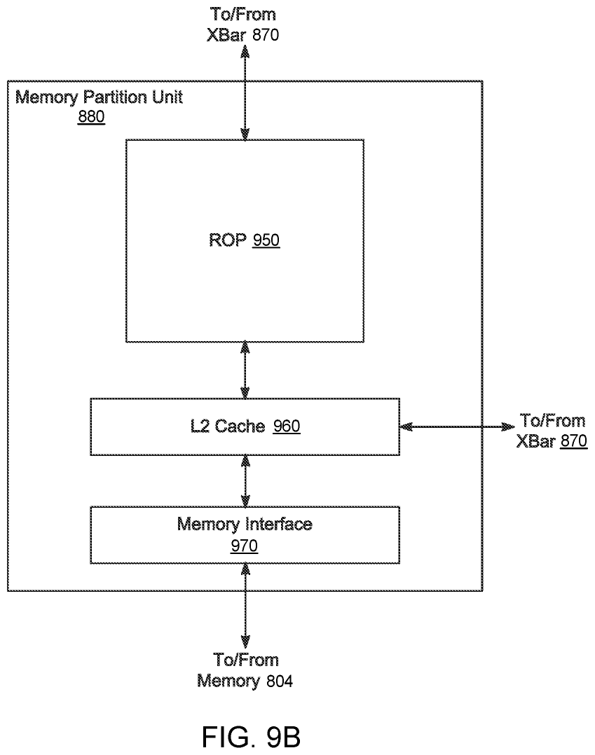

A naive solution to the problem of utilizing the scale metadata in an MMA circuitry may involve, for example: having different global memory layouts for A and B matrices, thereby requiring software to write two copies of scale metadata resulting in higher global memory usage and increased software complexity; high quantization global memory costs for storing scale metadata resulting in higher global memory usage and inefficient bandwidth usage; and inefficient resource usage when transferring scale metadata in/out of a processing resource (e.g., a streaming processor (SM), see FIG. 9A).

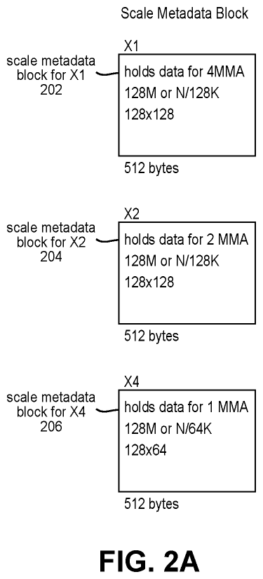

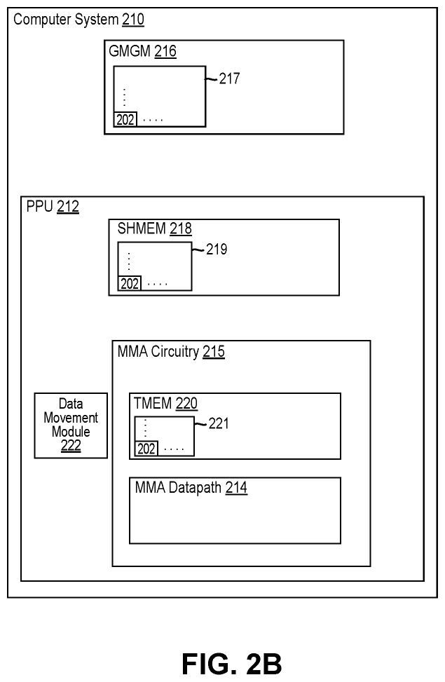

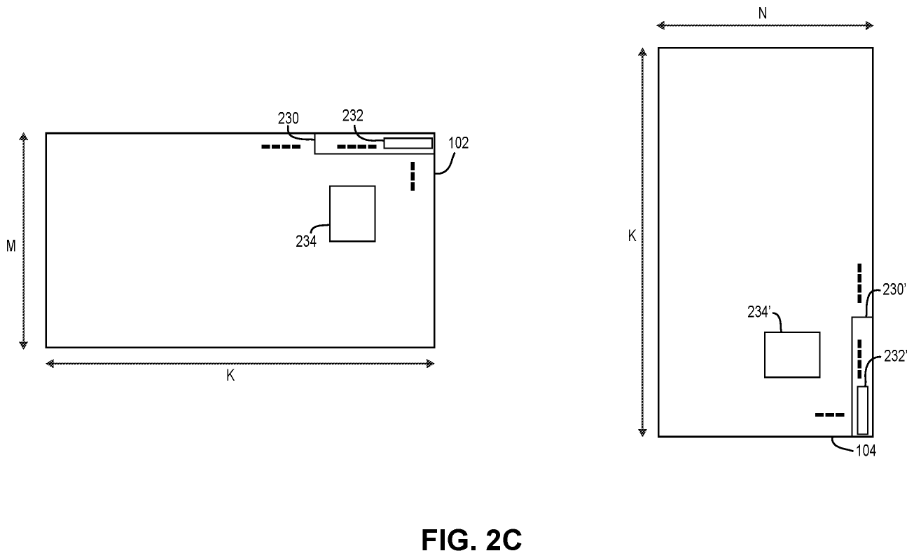

Embodiments of the present disclosure provide a scale metadata block layout that enables efficient movement of the scale metadata through the memory hierarchy of a computer system, minimizes quantization effects, reduces software complexity, and provides efficient use of memory storage. FIG. 2A schematically illustrates examples of a scale metadata block data structure that is used to represent scale metadata in embodiments of the present disclosure.

Example scale metadata blocks 202, 204, and 206, each is a 512 byte block of scale metadata (e.g., scale factors). The scale metadata block represents sufficient scale metadata for up to 128 rows of A matrix or 128 columns of B matrix with varying numbers of elements in the K dimension. The choice of 128 rows of A matrix or 128 columns of B matrix allows for compact memory layout representation with no additional data movement/manipulation required for moving the scale metadata through the memory hierarchy and with low quantization overhead. Note that, in some embodiments, the scale metadata layout is quantized to 128 rows of A matrix or 128 columns of B matrix as well as different number of elements in the K dimension.

According to embodiments herein described, the scale metadata block has a fixed size of 512 bytes, and always contains enough data for 128 rows of the A matrix or columns of the B matrix. The difference is that, depending on the number of scale factors per data path depth (e.g., 1, 2, or 4), that scale metadata block supports different widths of the A or B matrix. For example, considering a data path depth of 64, with the X4, X2, and X1 formats, widths (i.e., K direction) of 64, 128, and 256 of A or B matrix can be covered by the scale metadata block.

In the illustration shown in FIG. 2A, scale metadata block 202 comprises scale factors according to the “X1” format, i.e., an implementation with 1 scale factor per data path depth along a row of the A matrix or column of the B matrix. Scale metadata block 204 comprises scale factors for the “X2” format, i.e., an implementation with 2 scale factors per data path depth along a row of the A matrix or column of the B matrix, and scale metadata block 206 comprises scale factors for an “X4” format, i.e., an implementation with 4 scale factors per data path depth along a row of the A matrix or column of the B matrix.

The scale metadata block layouts shown in FIG. 2A provide a block of 512 bytes. regardless of whether the number of scale factors per data path depth along a row of the A matrix or column of the B matrix is 1 (X1), 2 (X2), or 4 (X4), and regardless of the dimensions of the A matrix and B matrix. In the block, each scale factor is represented in a byte.

Scale metadata block 202 holds sufficient scale metadata (i.e., scale factors) for 128 rows of A matrix or 128 columns of B matrix. In a hardware architecture in which the dot product width is 128, for example, the scale metadata block 202 includes scale factors for 4 MMA operations.

Block 204, which includes 2 scale factors per data path depth along a row of A or column of B, holds sufficient scale metadata (i.e., scale factors) for 128 rows of A matrix or 128 columns of B matrix. In a hardware architecture in which the dot product width is 128, for example, the scale metadata block 204 which includes 2 scale factors per row or column includes scale factors for 2 MMA operations. That is, each dot product utilizes 2×128 scale factors, providing sufficient scale factors in the 512 bytes for two such dot products.

Block 206, which includes 4 scale factors per data path depth along a row of A or column of B, holds sufficient scale metadata (i.e., scale factors) for 128 rows of A matrix or 128 columns of B matrix. In a hardware architecture in which the dot product width is 128, for example, the scale metadata block 206 which includes 4 scale factors per data path depth along a row of A or column of B includes scale factors for 1 MMA operation. That is, given the data path depth of 128, at 4 scale factors per data path depth, each MMA operation requires 512 (i.e., 4×128) scale factors, and therefore a single MMA operation requires the entire 512 bytes (e.g., each scale factor is represented in a byte) of the block.

Table 2 below illustrates example associations between the number of scale factors per data path depth, the scale metadata vector length and the size of matrices A/B covered by the scale metadata block for some example data path depths, according to some embodiments:

| | | | Size of A | Size of B |
|---|---|---|---|---|
| | Number of | | covered by | covered by |
| | scale factors | | scale | scale |
| Data path | per data path | Scale metadata | metadata | metadata |
| depth | depth | vector size | block | block |
| 96 | 4 (X4) | 24 | 128 × 96 | 96 × 128 |
| 96 | 2 (X2) | 48 | 128 × 192 | 192 × 128 |
| 96 | 1 (X1) | 96 | 128 × 384 | 384 × 128 |
| 64 | 4 (X4) | 16 | 128 × 64 | 64 × 128 |
| 64 | 2 (X2) | 32 | 128 × 128 | 128 × 128 |
| 64 | 1 (X1) | 64 | 128 × 256 | 256 × 128 |
| 48 | 4 (X4) | 12 | 128 × 48 | 48 × 128 |
| 48 | 2 (X2) | 24 | 128 × 96 | 96 × 128 |
| 48 | 1 (X1) | 48 | 128 × 192 | 192 × 128 |
| 32 | 4 (X4) | 8 | 128 × 32 | 32 × 128 |
| 32 | 2 (X2) | 16 | 128 × 64 | 64 × 128 |
| 32 | 1 (X1) | 32 | 128 × 128 | 128 × 128 |

As seen in the above description of FIG. 2A, the scale metadata block's layout and utilization is the same for the A matrix and the B matrix in a MMA calculation.

Another key aspect of the scale metadata block (e.g., 202, 204 and 206) in embodiments of the present disclosure, is that it enables the scale metadata to be stored in the same layout at the various levels of the memory hierarchy. FIG. 2B illustrates that, for example, in a computer system 210, the scale metadata block 202 (e.g., introduced in FIG. 2A) can be stored in the global memory (GMEM) 216, in the shared memory (SMEM) 218 in a parallel processing unit (PPU) 212 located in the computer system 210, and/or in a device memory (e.g., identified as tensor memory or TMEM here) 220 of a MMA circuitry 215 located in the PPU 212. The scale metadata block 202 layout is defined to enable it to be moved, for example, by a data movement module 222 (e.g., a TMAU module, described later), from GMEM to SMEM and/or TMEM, without additional data manipulation. For example, copies of block 202 may exist in the GMEM, SMEM and/or TMEM at some point during the operation of the computer system. In GMEM 216, all scale metadata of one of the matrices A or B may be stored in a plurality scale metadata blocks 217 and scale metadata block 202 would be one of the blocks in the plurality of scale metadata blocks 217. In SMEM 218 and TMEM 220, the respective pluralities of scale metadata blocks 219 and 221, respectively, may be copies of portions of the plurality of scale metadata blocks 217 in GMEM 216. For example, GMEM 216 may store the scale metadata for the entire A matrix of operands, the scale metadata of a subset of the rows of the A matrix may be copied to SMEM 218, and a subset of that in SMEM may be copied to TMEM 220 for consumption by the MMA circuitry.

FIG. 2C schematically illustrates an example area in A or B matrix that is mapped by a scale metadata block, a depth vector mapped to the A or B matrix, and a scale metadata vector, in accordance with some embodiments of the present disclosure.

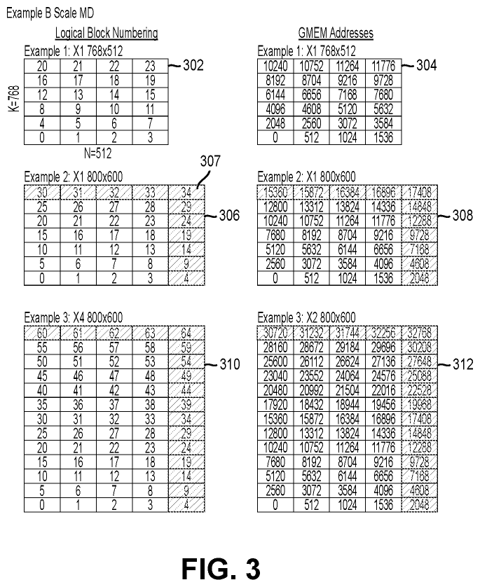

In some embodiments, a plurality of scale metadata blocks (also referred to as scale metadata block data structures) are arranged in a manner shown in FIG. 3 or similar in a global memory of a computer system and, during calculation of the multiplication of A and B matrices by an MMA circuit of the computer system, in a device memory connected to the MMA circuit.

Each of the scale metadata blocks may correspond to an area in one of A or B matrices (e.g., area 234 in A matrix 102 or area 234′ in B matrix). That is, when a scale metadata block is said to correspond to an area 234, that scale metadata block's scale factors are applied in the MMA calculation to scale the operands in that area of the A or B matrix.

FIG. 2C also conceptually illustrates a depth vector in relation to A and B matrices. In some embodiments, the depth vector is defined based on the data path depth of the MMA circuit. For example, the depth vector is defined such that the length of the depth vector is the same as the data path depth of the MMA circuitry. The data path depth may be the number of processing lanes in the MMA circuit that can accept simultaneous inputs. For example, the data path depth may be the number of A matrix parameters or the number of B matrix parameters that can be simultaneously input to the MMA circuit.

Each scale metadata block data structure may include s scale factors for a respective area (e.g., 234, 234′) defined by p rows and q columns in the A matrix or q rows and p columns in the B matrix. The value of q may be determined based on the length of the depth vector, s, p and a scale factor allocation associated with the depth vector length.

The scale factor allocation may be specified as a number of scale factors. For example, the scale factor allocation may be the number of scale factors per length of vector length, according to one of a plurality of layouts. Example layouts that can be used in embodiments can include the X1, X2 and X4 layouts mentioned above.

The value of q can be determined based on the relation d*s/(p*r), where d is the length of the depth vector and r is the scale factor allocation.

In one example, s=512, p=128, the first length of the depth vector is determined in accordance with the data path of the MMA circuitry, and r is determined based on the first vector length and according to one of the X1, X2 or X4 layouts.

In each scale metadata block data structure in the plurality of scale metadata block data structures, the s scale factors corresponding to the respective area of A or B matrices is arranged such that scale factors corresponding to one column of the A matrix are interleaved with scale factors of one or more other columns of the A matrix, or scale factors corresponding to one row of the B matrix are interleaved with scale factors of one or more other rows of the B matrix.

The interleaving may include arranging scale factors of the one or more other columns of the A matrix in between scale factors corresponding to a first set of consecutive rows in the one column of the A matrix and scale factors corresponding to a second set of consecutive rows in the one column of the A matrix, or arranging scale factors of the one or more other rows of the B matrix in between scale factors corresponding to a first set of consecutive columns in the one row of the B matrix and scale factors corresponding to a second set of consecutive columns in the one row of the B matrix. The one or more other columns of the A matrix may comprise r−1 of the other columns, or the one or more other rows of the B matrix may comprise r−1 other rows, where r is the scale factor allocation.

In many real-world applications that are typically run on computer systems such that shown in FIG. 2B, the operand matrices for MMA can be significantly larger than the 128×128 or the 128×64 operand matrices discussed in relation to FIG. 2A. A or B matrices larger than the area (e.g., 234, 234′) corresponding to a scale metadata block would require a plurality of scale metadata blocks. FIG. 3 shows examples of the logical organization of scale metadata blocks (e.g., such as scale metadata blocks 202, 204 and 206) to correspond to different sizes of operand matrices, in memory (e.g., GMEM 216). On the left, the logical block numbering is shown for the plurality of scale metadata blocks of X1 and X4, and on the right corresponding GMEM addresses are shown for each layout of logical numbered blocks.

The logical numbering layout 302 and the corresponding address layout 304 in the top row of layouts, show the organization of a plurality of scale metadata blocks comprising scale factors for an operand matrix of 768×512 dimensions in the K and N directions, respectively. Since the format is X1 (see 202 in FIG. 2A), each scale metadata block includes scale factors for block of K=128 and N=128 in an operand matrix (“N” considering the B matrix). Therefore, the example operand matrix of 768×512 would require 4 scale metadata blocks (i.e., 512/128) in the N direction and 6 scale metadata blocks (i.e., 768/128) in the K direction. Thus, the 768×512 matrix requires 24 scale metadata blocks in the X1 format, and the logical numbering goes from 0-23.

Layout 304 shows the address layout in GMEM corresponding to the logical number layout 302 for the scale metadata blocks of the 768×512 operand matrix. The address layout 304 shows the logical block numbers 0, 1, 2, 3, 4, 5, . . . 23 mapping to GMEM byte addresses (or address offsets) 0, 512, 1024, 1536, 2048, . . . , 11776, illustrating the 512 byte offset between two consecutive scale metadata blocks. Since the operand matrix of 768×512 is evenly divisible by the scale metadata block (providing scale factors for 128×128 block in the X1 implementation), there is no quantization of operands at the edges of the operand matrix for scale factors.

Logical block layout 306 and corresponding address layout 308 show a mapping of the scale metadata blocks comprising the scala factors in the X2 format for an 800×600 operand matrix. Neither 800 nor 600 is evenly divisible by 128 (M/N or K dimensions of the operand block represented by a scale metadata block). Therefore, in example embodiments, in each dimension the last block (i.e., the block after the last evenly divisible block) in the 800×600 operand matrix is quantized with respect to the scale factor mapping. For example, logical blocks 4, 9, 14, . . . 34 of scale metadata may overlap 88 (600−4×128) columns each, and logical blocks 30, 31, 32, . . . , 34 of scale metadata may overlap only 32 (800−6*128) rows each. Quantized blocks 307 are indicated by shading in the layouts in FIG. 3.

Layout 308 shows the address layout in GMEM corresponding to the logical number layout 306 for the scale metadata blocks of the 800×600 operand matrix. The address layout 308 shows the logical block numbers 0, 1, 2, 3, 4, 5, 6 . . . 34 of scale metadata blocks mapping to GMEM byte addresses (or address offsetsz) 0, 512, 1024, 1536, 2048, 2560, . . . , 17408, illustrating the 512 byte offset between two consecutive scale metadata blocks.

Logical block layout 310 and corresponding address layout 312 show a mapping of the scale metadata blocks comprising the scale factors in the X4 format for a 900×700 operand matrix. Neither 900 nor 700 is evenly divisible by 128 (scale metadata block size). Therefore, in example embodiments, in each dimension the last block (i.e., the block after the last evenly divisible block) is quantized. For example, logical blocks 4, 9, 14, . . . 34 of scale metadata may include the remaining 60 (700−5×128) columns each, and logical blocks 60, 61, 62, . . . 64 of scale metadata may include the remaining 32 (900−12*64 (number of blocks*k-direction block size)) rows each.

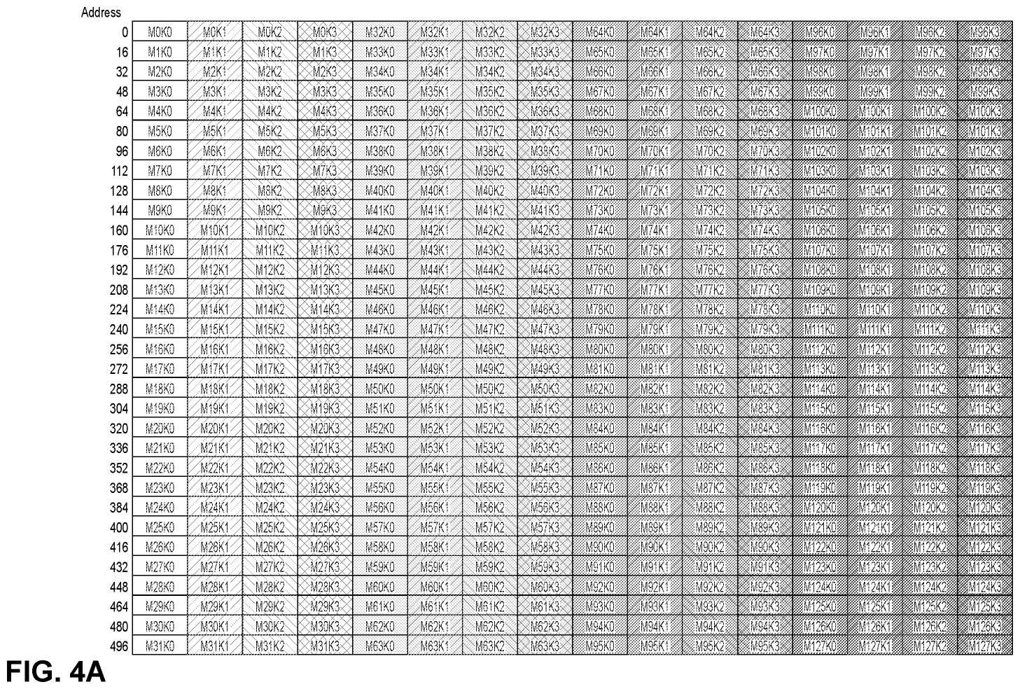

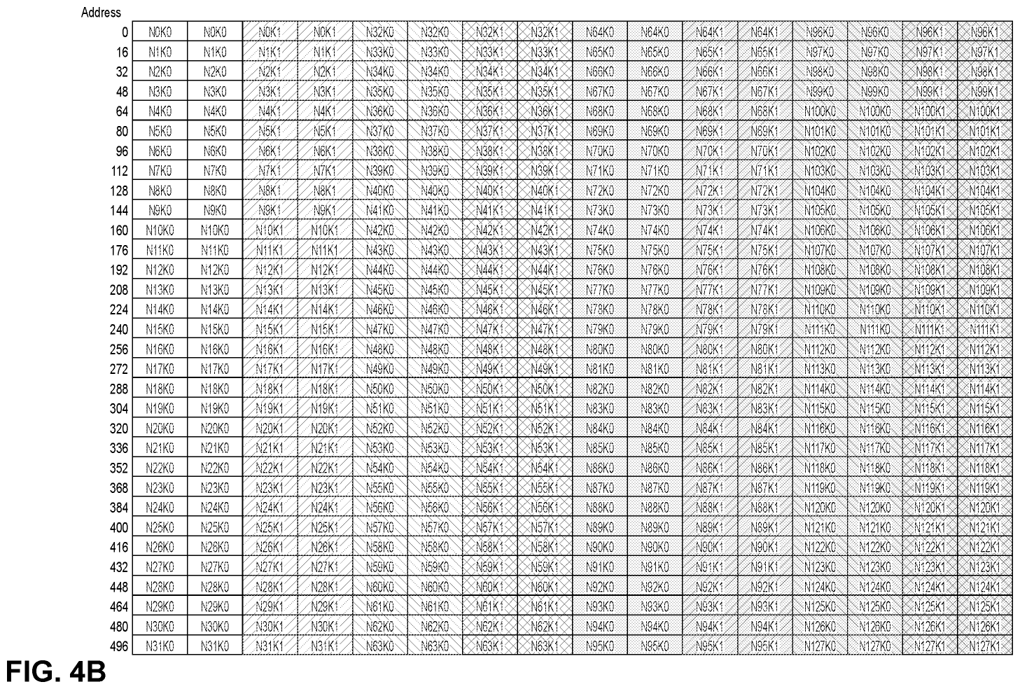

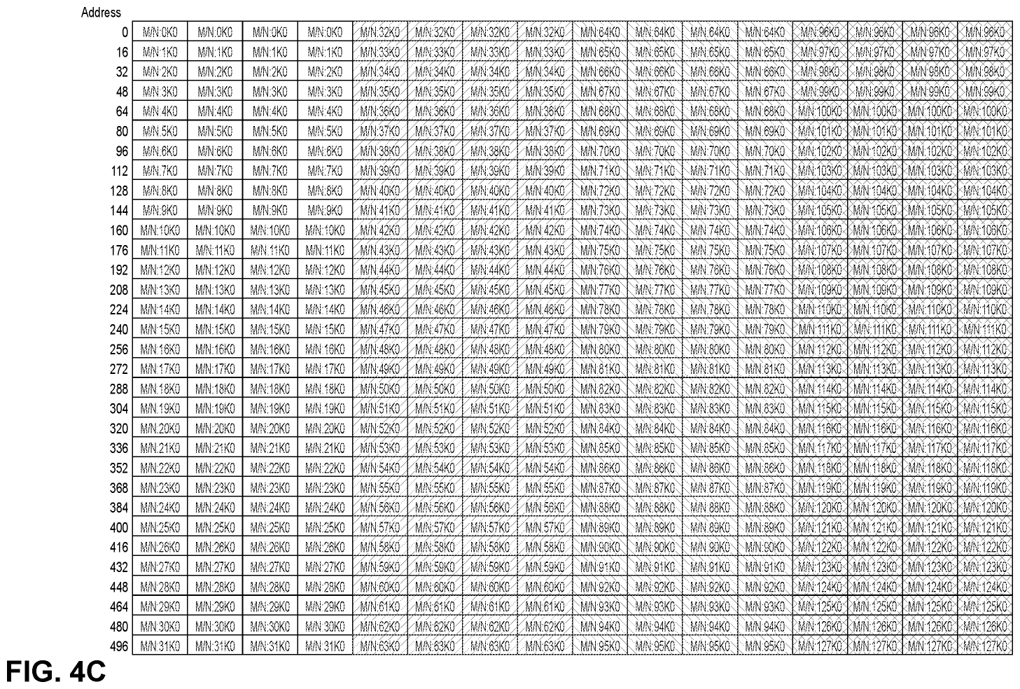

Layout 312 shows the address layout in GMEM corresponding to the logical number layout 310 for the scale metadata blocks of the 900×700 operand matrix. The address layout 312 shows the logical block numbers 0, 1, 2, 3, 4, 5, 6 . . . 64 of scale metadata mapping to GMEM byte addresses (or address offsets) 0, 512, 1024, 1536, 2048, 2560, . . . , 32768 of scale metadata, illustrating the 512 byte offset between two consecutive scale metadata blocks.

Whereas FIG. 3 illustrates how a plurality of scale metadata blocks are mapped to a matrix of operands, FIGS. 4A and 4B illustrate the mapping within each scale metadata block.

FIG. 4A shows an example mapping of the 512 bytes of a scale metadata block are respectively mapped to the A matrix, and FIG. 4B shows the mapping of a 512 byte scale metadata block to the B matrix, according to some embodiments of the present disclosure. The illustrated mapping is for the X1 format (e.g., scale metadata block 202) in which one scale factor is provided per datapath depth. The mapping is shown as a 32×16 byte arrangement.

FIG. 4A illustrates the scale metadata in the X1 format for the matrix A mapping to 128 rows in the M dimension (M=0 to 127) and, for each row, 4 columns in the K dimension (K=0 to 3). Thus, starting at the top left having index M0K0, going from top to bottom and left to right, the first four columns have element indices as M0K0, M1K0, . . . , M31K0 for the first column, M0K1, M1K1, . . . , M31K1 for the second column, M0K2, M1K2, . . . , M31K2 for the third column, M0K3, M1K3, . . . , M31K3 for the fourth column, and in the same pattern the second set of 4 columns having M32K0, M33K0, . . . , M63K0, M32K1, M32K1, . . . , M63K1, M64K2, M65K2, . . . , M95K2, M96K3, M97K3, . . . , M127K3, etc. It should be noted that each scale metadata element is 1 byte wide. It can be seen that the column pattern repeats every 4 bytes (e.g., columns starting with M0K0 and M32K0). The X1 format, the format of the layout in FIG. 4A, provides 1 scale factor for each column of B or for one row of A of a 128×128 block. The X1 layout in FIG. 4A shows that there are 4 scale factors along the K dimension (K=0 . . . 3) and 128 (M=0 . . . 127) along the M dimension.

The scale metadata layout in a scale metadata block for the B matrix is identical to that for the scale metadata layout in a scale metadata block for the A matrix shown in FIG. 4A, in the X1 format, with the index M replaced with N (N represents columns in the B matrix).

FIG. 4B illustrates scale metadata for a B matrix mapping to 128 rows in the N dimension (N=0 to 127) and, for each row, 4 columns in the K dimension (K=0 to 3). Thus, starting at the top left having index M0K0, going from top to bottom and left to right, the first four columns have element indices as, M0K0, M1K0, . . . , M31K0 in the first column, M0K1, M1K1, . . . , M31K1 in the second column, M0K2, M1K2, . . . , M31K2 in the third column, M0K3, M1K3, . . . , M31K3 in the fourth column, and in the same pattern the second set of 4 columns having M32K0, M33K0, . . . , M63K0, M32K1, M32K1, . . . , M63K1, M64K2, M65K2, . . . , M95K2, M96K3, M97K3, . . . , M127K3, etc. It should be noted that each scale metadata element is 1 byte wide. The X2 format provides 2 scale factors per datapath depth. FIG. 4B illustrates that there are 2 scale factors in the K dimension (K=0 and 1, 2 and 3) and 128 in the N dimension.

FIG. 4C illustrates scale metadata for an A or B matrix mapping to 128 rows in the M or 128 columns in the N dimension (M or N=0 to 127) and, for each row/column, 4 columns/rows in the K dimension (K=0 to 3). The X4 format provides four scale factor per datapath depth. FIG. 4C illustrates that there is 1 scale factor in the K dimension (K=0-3) and 32 in the M or N dimension. For example, Thus, FIGS. 4A, 4B and 4C illustrates that X1, X2, and X4 has sufficient scale metadata for 4, 2, and 1 dot product, respectively.

It can be seen from the arrangement of the logical scale metadata blocks 302, 304 and 306, that according to example embodiments, quantization if any occurs only at the edges of the logical arrangement of the scale metadata blocks.

The scale metadata block as provided in this disclosure enables the scale data for a matrix multiplication to be sourced from GMEM, and copied through to shared memory (SMEM) and from the shared memory to the device memory (e.g., TMEM) of the MMA circuitry. In some embodiments, a first command (e.g., UTMA*/UBLKCP instructions) is used to move the metadata from GMEM to SMEM, and a second command (e.g., a UTCCOPY instruction) to move the metadata from SMEM to TMEM. In some embodiments, block copy instructions can operate to move scale metadata based on the size of the scale metadata block (e.g., 512 bytes). The MMA circuitry may be configured to consume the scale metadata from TMEM. In some embodiments, the MMA circuitry may be configured to consume the scale metadata from SMEM.

In some embodiments, the MMA circuitry may calculate scale metadata for A and B matrices, and write the calculated scale metadata to the associated SM's register file. Some embodiments may provide for the calculated scale metadata from the SM's register file to be stored in SMEM as an arrangement of scale metadata blocks, and for that scale metadata to be moved to GMEM without further manipulating the data.

By eliminating the necessity to perform any additional data manipulations when copying the scale metadata between layers of the memory hierarchy, layout of the scale metadata block as defined in this disclosure enables speed of light (SOL) movement of scale metadata through the memory hierarchy.

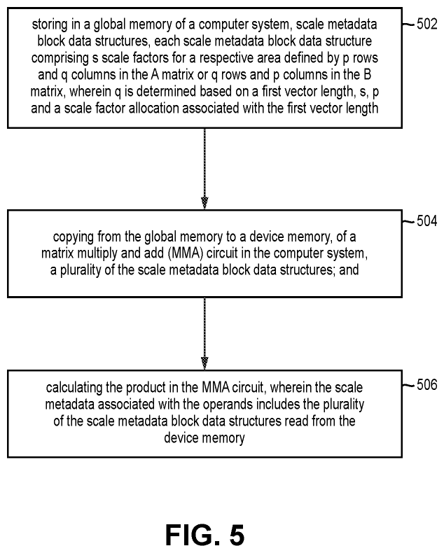

FIG. 5 illustrates a flowchart 500 of a process to calculate a product of an A matrix and a B matrix based on operands of the A and B matrices and scale metadata associated with the operands. As described above, the matrix multiplication may be in many applications.

At 502, storing in a global memory of a computer system is performed of scale metadata block data structures, each scale metadata block data structure comprising s scale factors for a respective area defined by p rows and q columns in the A matrix or q rows and p columns in the B matrix. q is determined based on a depth vector length, s, p and a scale factor allocation associated with the depth vector length. An example technique for the determination of q is described above. The scale metadata for the A matrix and the B matrix may be stored in different pluralities of scale metadata block data structures. The storing may, for example, be initiated by software running on the CPU of the computer system.

As described above, within each scale metadata block data structure, the columns may be interleaved. Also as described above, the scale metadata block data structures may have at least some scale metadata block data structures that cover an area in the A or B matrices in which the number of operands is different than others of the scale metadata block data structure.

At 504, copying from the global memory to a device memory of a MMA circuit in the computer system is performed of a plurality of the scale metadata block data structures. For example, during the MMA operation, a data movement module (e.g., 222 or TMAU module discussed below) may read groups of the scale metadata block data structures and store the read groups of scale metadata block data structures to the device memory (e.g., TMEM) of the MMA circuit either directly, or after intermediately storing in the SMEM.

At 508, calculating the product in the MMA circuit is performed where the scale metadata associated with the operands includes the plurality of the scale metadata block data structures read from the device memory. In some embodiments, the scale metadata block structures may be read from the SMEM. Equation 1, Equation 2 or another equation may be used to calculate the product of A and B matrices with the use if scale factors.

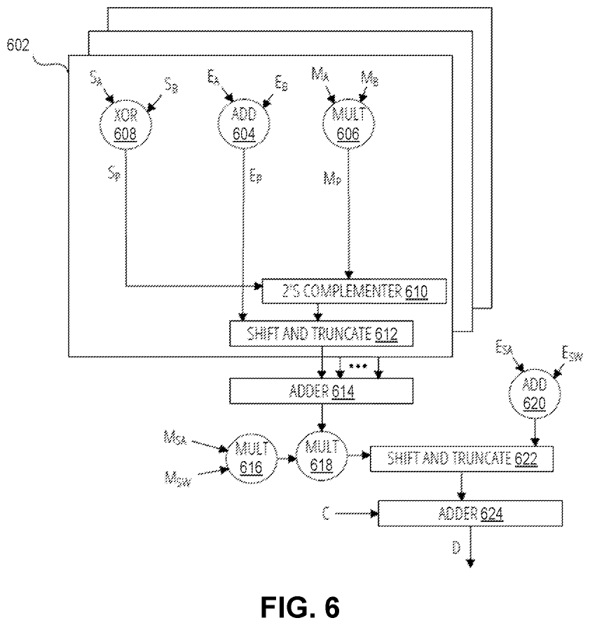

In some example embodiments, MMA circuitry such as that described in relation to FIGS. 6 and/or 7A/7B may be used for the MMA operations described above. In order to optimize data movement along each of the processing lanes of the MMA circuitry, it is desirable to load scale metadata for multiple MMA instructions at once. The scale block structure of embodiments enable packing the scale metadata in a format where the scale metadata for respective dot product operations are interleaved along the K-direction (i.e., channel direction) in subsequent memory locations as indicated by the hatching pattern in FIGS. 4A-4B. The MMA circuitry then may use selectors in the instructions, to select from the interleaved columns (e.g., every 4th column in FIG. 4A) in the scale metadata in TMEM. This further facilitates efficient movement of data from GMEM to TMEM and subsequent consumption of that scale data by the MMA circuitry.

The packing pattern along the K-dimension may change depending on how many scale factors are specified for the MMA instruction in accordance with the number of scale elements per row/column represented in the scale metadata block.

The scale metadata block layout of embodiments allows K interleaving at 1 byte, 2 bytes, or 4 bytes, without changing the general layout. This facilitates software by avoiding the necessity for the software to separately provide for the different interleaving patterns.

The scale metadata block defined in example embodiments enable bulk data movement from GMEM through SMEM to TMEM, such that the input to the MMA circuitry can be kept fully utilized with minimal use of read-modify-write operations that would have been necessary if smaller granularity loads (e.g., smaller than 128) were used.

Viewed in another way, this also enables the cost of the bulk movement of scale metadata through the memory hierarchy to be amortized over several MMA operations.

It should also be noted that the 512 byte block provides for efficient storage utilization, because, for example, all of the bytes in the block are fully utilized.

Embodiments of this disclosure provide a compact memory layout of scale metadata regardless of scale metadata vector size. The scale metadata layout of embodiments efficiently utilizes memory at all levels of memory hierarchy (e.g., GMEM, SMEM, TMEM).

Embodiments provide a consistent memory layout of scale metadata for A and B matrices for an MMA circuit regardless of scale meta data usage. The scale metadata for A and B matrices have identical global memory layouts allowing the scale metadata to be used as A or B matrix.

The capability to load scale meta data without need for additional data manipulation or movement. Additional data manipulation or movement may reduce performance, increase software complexity and increase power consumption. Efficient (e.g., 100% SOL) usage of resources is provided when transferring scale metadata from global memory to tensor memory and from streaming processor (SM) register file to global memory.

FIG. 6 depicts an example use of narrow operand sizes in the data path to further lower precision in the data path of vector multiply units 602 utilizing VS-Quant FP4 data formats. In this disclosure, “FP” refers to floating point data formats, INT refers to integer data formats, and INT32 refers to the well-known 32-bit fixed point representation of integer data types. Exemplary embodiments may be depicted utilizing INT32 accumulation, but the disclosed mechanisms are applicable to INT accumulation in other bit widths as well.

Example FP8 floating point data formats that can be utilized in example embodiments herein comprise two encodings—E4M3 and E5M2, where the name encodes the number of exponent (E) and mantissa (M) bits. For this data format, the term “mantissa” refers to IEEE 754 standard's trailing significand field (i.e. bits not including the implied leading 1 bit for normal floating point numbers). The E4M3 encoding may be particularly applicable for representing weight and activation tensors (e.g., in deep learning applications), and the E5M2 encoding may be particularly applicable for representing gradient tensors.

Quantization enables efficient acceleration of deep neural networks by reducing model memory footprint and exploiting low-cost integer math hardware units. Quantization maps floating-point weights and activations in a trained model to low bit-width integer values using scale factors. Excessive quantization, reducing precision too aggressively, results in degradation of the accuracy of the model. When scale factors are shared at a coarse granularity across many dimensions of each tensor, effective precision of individual elements within the tensor are limited.

The description of the following exemplary embodiments includes logic components such a XOR, addition, complementing, shifting, truncation, alignment, and so on. Unless otherwise indicated, these components may be implemented in any number of manners that are well-known and understood in the art.

FIG. 6 depicts an embodiment micro-architecture for the data path of a vector multiply unit (MAC; e.g., including MMA circuit) that can be used in some embodiments of the present disclosure. The micro architecture shown in FIG. 6 is described in the NARROW FP APPLICATION. This micro-architecture, which utilizes operand sizes, may demonstrate improved area and energy efficiency over conventional mechanisms.

The depicted embodiment comprises a data path for VS-Quant FP4 (e.g., E2M1 encoded) vectors and a per-vector FP4 (e.g., unsigned E3M1) scale factor. Utilization of 4-bit precision and quantized 4-bit precision enables a significant reduction in the area and energy consumption of the vector multiply-accumulate unit logic. Although the example embodiment utilizes the E2M1 (signed) and E3M1 (unsigned) formats specifically, other FP4 and quantized FP4 formats may also be utilized (e.g., E1M2, E0M3, E3M0 vectors with E4M0, E2M2, E1M3, E0M4 per-vector scale factors depending on the constraints of the implementation. In addition, the bit width of per-vector scale factors may be increased beyond four bits (e.g., to eight bits) with some corresponding increase in logic size and/or complexity.

The VS-Quant FP4 data format comprises a vector of FP4 (E2M1, E1M2, E0M3) formatted elements and an FP4 or FP8 formatted scale factor applied to all elements in the vector. VS-Quant LOG4 comprises a vector of elements each represented in fixed-point exponent-only formats (E3.0, E2.1, E1.2) and an exponent bias scale factor applied to each element in the vector. Conventional block data formats such as Block FP and Microsoft-FP comprise a vector of fixed-point formatted elements and a scale factor that is applied only to the exponent of these elements.

In the data path, exponents of two operands A and B are added (adder 604), mantissas are multiplied (mantissa multiplier 606), and sign bits are XORed (XOR logic 608). The product mantissa MP is complemented based on the product sign bit SP (2's complementer 610). The result is shifted and truncated (shifter and truncater 612) based on the product exponent EP to generate a partial product.

The partial products from the multiply units 602 are reduced (added) in an adder 614. Post-processing of the reduced result is then performed. The reduced result is multiplied with the product of MSA and MSW (multiplier 616 and multiplier 618). MSA represents a mantissa scale factor for input activations of the neural network layer being processed, and MSW represents a mantissa scale factor for weights of the Because the mantissa scale factors are E3M1 format, the multiplier 616 comprises a two-bit multiplier yielding a four-bit product. Multiplier 618 performs a four-bit multiply on the output of adder 614 layer.

The exponent scale factors (ESA for activations and ESW for weights) are added (adder 620) and applied as a shift amount on the output of multiplier 418, with appropriate truncation (shifter and truncater 622). The result is added to the third 32-bit 2's-complement operand (C, e.g. a running sum) to produce the final output D (adder 624).

The utilization of FP4 format, per-vector scaling introduces only a small overhead to scale the dot-product outputs and to perform accumulation in INT32 format.

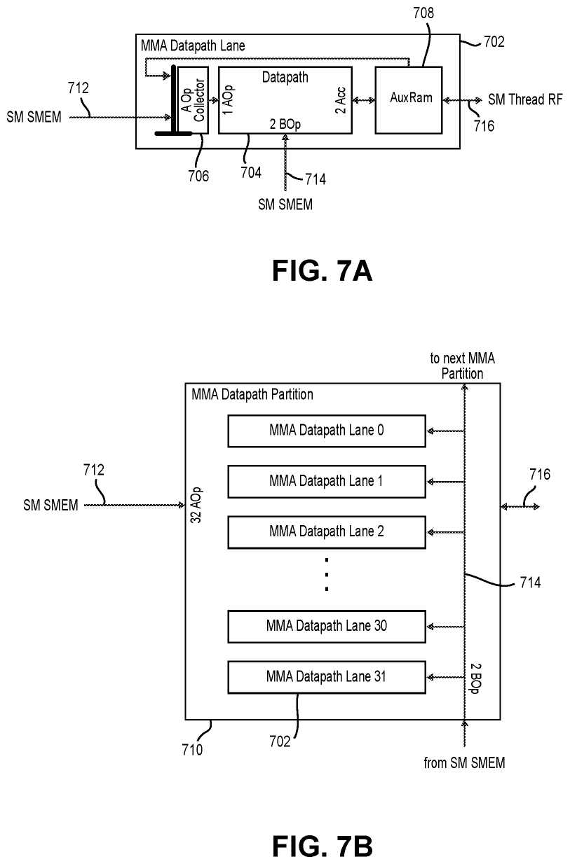

FIG. 7A and FIG. 7B illustrate a portion of a processor (a datapath processor) that includes a datapath configured to implement matrix operations according to some embodiments. In an example embodiment, the datapath processor 710 may be located in a streaming processor. For example, in the streaming multiprocessor (SM) 940 illustrated in FIG. 9A, the plurality of processor cores 1050 may include one or more datapath processors 710.

The portion of a processor 710 includes a plurality of datapath lanes 702 that each comprises datapath processing circuitry 704 configured to implement matrix operations.

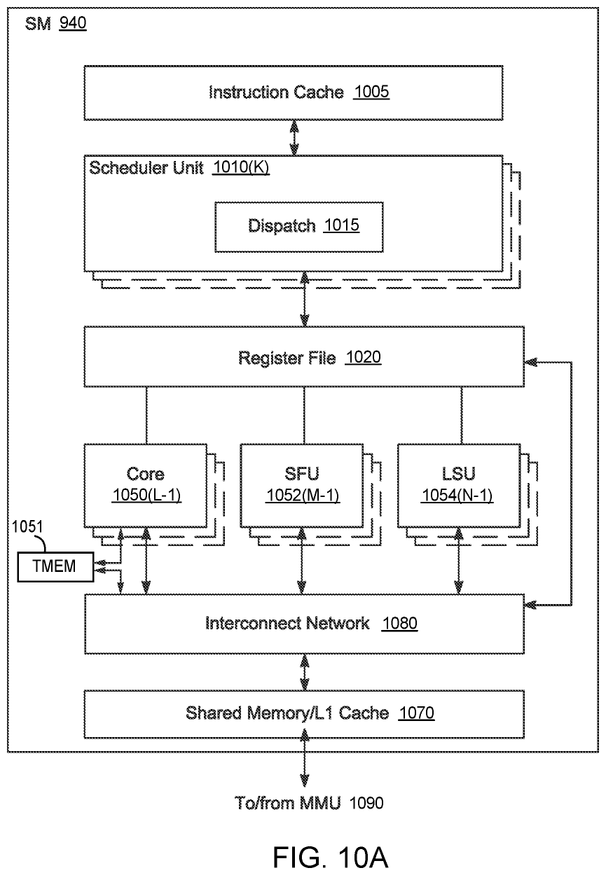

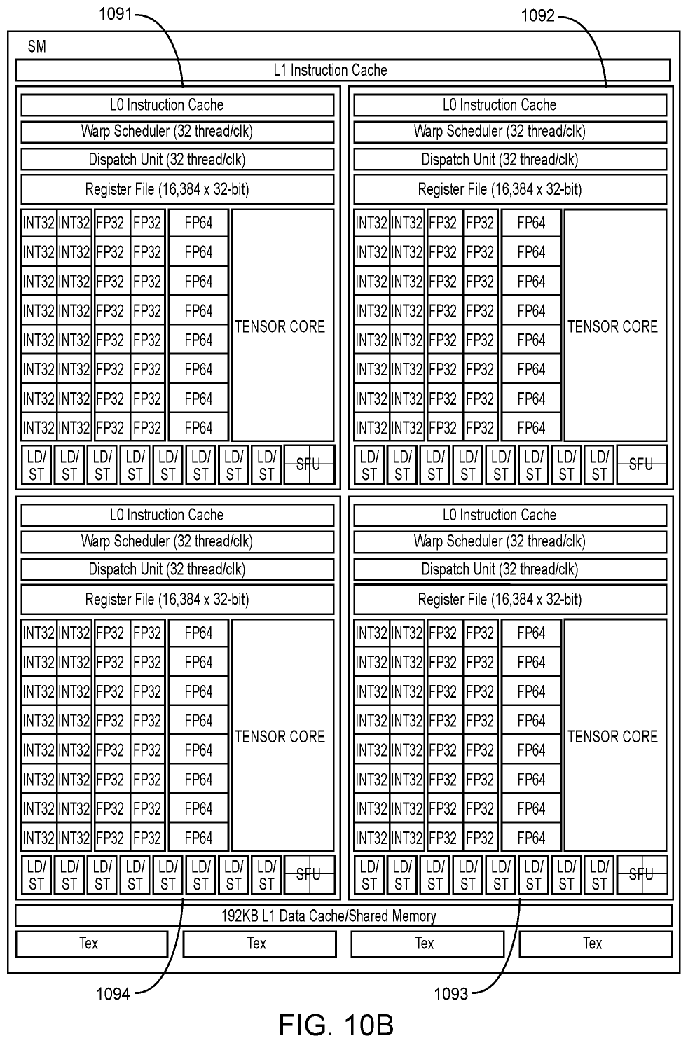

Each datapath processing circuitry 704 may be configured with a first memory component 706, such as, for example, a plurality of registers, and, optionally, a second memory component 708, such as, for example, an auxiliary RAM. In the above described example of convolution calculation, in order for a datapath processing circuitry 704 in a datapath lane 702 to perform its portion of a MMA calculation, the weights matrix (“B matrix”) elements are obtained from the first memory component 706, the elements of the activations matrix (“A matrix”) are obtained from a local buffer or SMEM (e.g., SM 940 shared memory 1070) over an interface 714. The first memory component 706 is configured to receive weights matrix elements from a SMEM over an interface 712. In some embodiments, the SMEM from which weights matrix elements are obtained and the SMEM from which activations matrix elements are obtained are the same SMEM. For example, the SMEM 1070 on SM 940 may be configured to receive data of both the activation matrix and the weights matrix from a global memory or L2 memory (e.g., interface 1090 shown in FIG. 10A), and to provide, via the interconnect network 1080, the activations matrix to the datapath processing circuitry 704 and the weights matrix to the second memory component 708. The second memory component 708 may be connected via an interface 716 to a register file, such as, for example, register file 1020 of SM 940.

In an embodiment, the second memory component 708 is a local memory (sometimes referred to herein as “auxiliary memory”, “tensor memory” or TMEM (e.g., TMEM 951)) that is configured to store data of the weights matrix in a manner that is respectively accessible by each datapath lane. An example optional TMEM 951 is shown in FIG. 9A.

In some embodiments, a bus 714 may be used to share the elements of the activations matrix among all datapath lanes. In some embodiments, the activations matrix elements may be obtained from the SMEM via bus 714.

In the illustrated embodiment, the portion 710 of the datapath processor comprises 32 datapath lanes 702, and a plurality of the portions 710 (also referred to as “partitions” or “sub-partitions”) are connected so that they can operate as one datapath processor. For example, in an embodiment, a 128-element activation vector is used as the B operands to the datapath processor such that each of the 128 elements of the activation vector is an B operand used by a respective one of the datapath lanes 702. U.S. application Ser. Nos. 18/458,638 and 18/449,381, filed by NVIDIA CORPORATION, and herein incorporated by reference in its entirety, describes the data path of FIGS. 7A-7B.

### Example GPU Architecture

An example illustrative architecture of PPU (e.g., GPU) described in relation to FIGS. 1-6, is described. The following information is set forth for illustrative purposes and should not be construed as limiting in any manner. Any of the following features may be optionally incorporated with or without the exclusion of other features described.

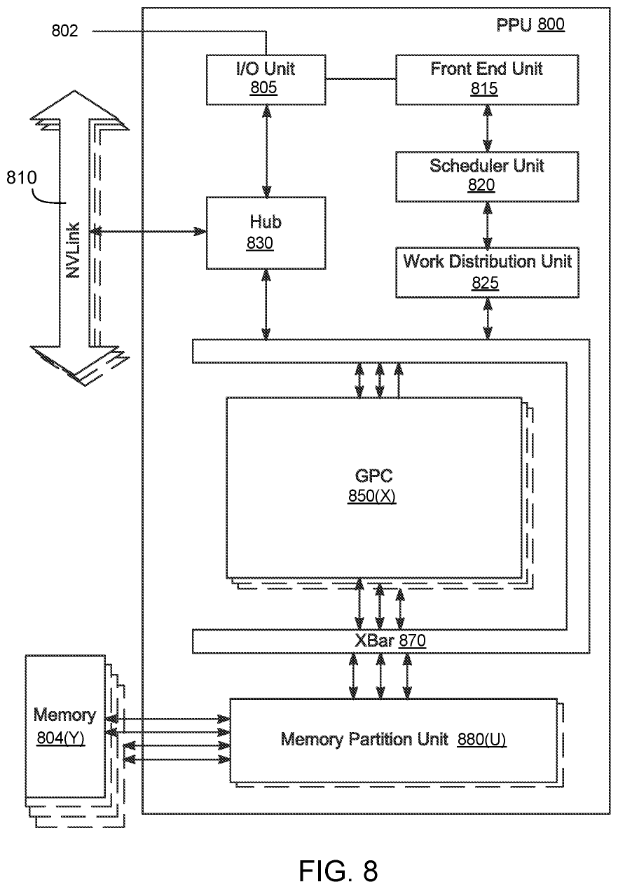

FIG. 8 illustrates a parallel processing unit (PPU) 800 that may be included on a dielet of a PPU, in accordance with an embodiment. In an embodiment, the PPU 800 is a multi-threaded processor that is implemented on one or more integrated circuit devices. The PPU 800 is a latency hiding architecture designed to process many threads in parallel. A thread (e.g., a thread of execution) is an instantiation of a set of instructions configured to be executed by the PPU 800. In an embodiment, the PPU 800 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 800 may be utilized for performing general-purpose computations. In some other embodiments, PPU 800 configured to implement large neural networks in deep learning applications or other high performance computing applications.

One or more PPUs 800 may be configured to accelerate thousands of High Performance Computing (HPC), data center, and machine learning applications. The PPU 800 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 8, the PPU 800 includes an Input/Output (I/O) unit 805, a front end unit 815, a scheduler unit 820, a work distribution unit 825, a hub 830, a crossbar (Xbar) 870, one or more general processing clusters (GPCs) 850, and one or more partition units 880. The PPU 800 may be connected to a host processor or other PPUs 800 via one or more high-speed NVLink 810 interconnect. The PPU 800 may be connected to a host processor or other peripheral devices via an interconnect 802. The PPU 800 may also be connected to a memory comprising a number of memory devices 804. In an embodiment, the memory 804 may comprise a number of dynamic random access memory (DRAM) devices. The DRAM devices may be configured as a high-bandwidth memory (HBM) subsystem, with multiple DRAM dies stacked within each device.

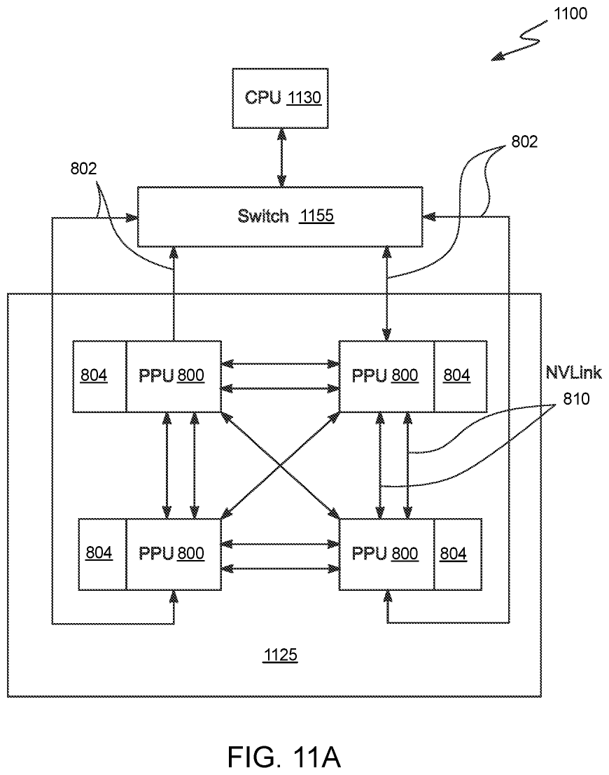

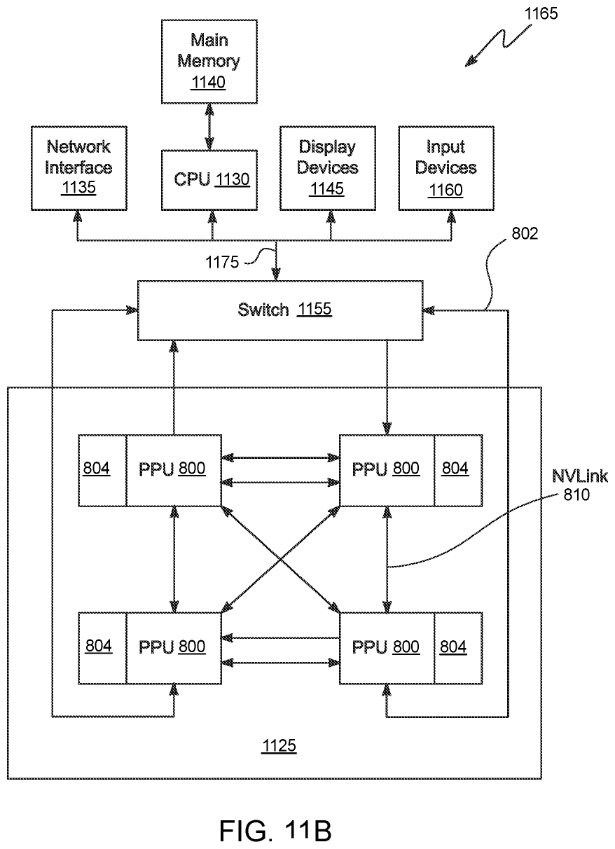

The NVLink 810 interconnect enables systems to scale and include one or more PPUs 800 combined with one or more CPUs, supports cache coherence between the PPUs 800 and CPUs, and CPU mastering. Data and/or commands may be transmitted by the NVLink 810 through the hub 830 to/from other units of the PPU 800 such as one or more copy engines, a video encoder, a video decoder, a power management unit, etc. (not explicitly shown). The NVLink 810 is described in more detail in conjunction with FIG. 11A and FIG. 11B.

The I/O unit 805 is configured to transmit and receive communications (e.g., commands, data, etc.) from a host processor (not shown) over the interconnect 802. The I/O unit 805 may communicate with the host processor directly via the interconnect 802 or through one or more intermediate devices such as a memory bridge. In an embodiment, the I/O unit 805 may communicate with one or more other processors, such as one or more of the PPUs 800 via the interconnect 802. In an embodiment, the I/O unit 805 implements a Peripheral Component Interconnect Express (PCIe) interface for communications over a PCIe bus and the interconnect 802 is a PCIe bus. In alternative embodiments, the I/O unit 805 may implement other types of well-known interfaces for communicating with external devices.

The I/O unit 805 decodes packets received via the interconnect 802. In an embodiment, the packets represent commands configured to cause the PPU 800 to perform various operations. The I/O unit 805 transmits the decoded commands to various other units of the PPU 800 as the commands may specify. For example, some commands may be transmitted to the front end unit 815. Other commands may be transmitted to the hub 830 or other units of the PPU 800 such as one or more copy engines, a video encoder, a video decoder, a power management unit, etc. (not explicitly shown). In other words, the I/O unit 805 is configured to route communications between and among the various logical units of the PPU 800.

In an embodiment, a program executed by the host processor encodes a command stream in a buffer that provides workloads to the PPU 800 for processing. A workload may comprise several instructions and data to be processed by those instructions. The buffer is a region in a memory that is accessible (e.g., read/write) by both the host processor and the PPU 800. For example, the I/O unit 805 may be configured to access the buffer in a system memory connected to the interconnect 802 via memory requests transmitted over the interconnect 802. In an embodiment, the host processor writes the command stream to the buffer and then transmits a pointer to the start of the command stream to the PPU 800. The front end unit 815 receives pointers to one or more command streams. The front end unit 815 manages the one or more streams, reading commands from the streams and forwarding commands to the various units of the PPU 800.

The front end unit 815 is coupled to a scheduler unit 820 that configures the various GPCs 850 to process tasks defined by the one or more streams. The scheduler unit 820 is configured to track state information related to the various tasks managed by the scheduler unit 820. The state may indicate which GPC 850 a task is assigned to, whether the task is active or inactive, a priority level associated with the task, and so forth. The scheduler unit 820 manages the execution of a plurality of tasks on the one or more GPCs 850.

The scheduler unit 820 is coupled to a work distribution unit 825 that is configured to dispatch tasks for execution on the GPCs 850. The work distribution unit 825 may track a number of scheduled tasks received from the scheduler unit 820. In an embodiment, the work distribution unit 825 manages a pending task pool and an active task pool for each of the GPCs 850. The pending task pool may comprise a number of slots (e.g., 32 slots) that contain tasks assigned to be processed by a particular GPC 850. The active task pool may comprise a number of slots (e.g., 4 slots) for tasks that are actively being processed by the GPCs 850. As a GPC 850 finishes the execution of a task, that task is evicted from the active task pool for the GPC 850 and one of the other tasks from the pending task pool is selected and scheduled for execution on the GPC 850. If an active task has been idle on the GPC 850, such as while waiting for a data dependency to be resolved, then the active task may be evicted from the GPC 850 and returned to the pending task pool while another task in the pending task pool is selected and scheduled for execution on the GPC 850.

The work distribution unit 825 communicates with the one or more GPCs 850 via XBar 370. The XBar 870 is an interconnect network that couples many of the units of the PPU 800 to other units of the PPU 800. For example, the XBar 870 may be configured to couple the work distribution unit 825 to a particular GPC 850. Although not shown explicitly, one or more other units of the PPU 800 may also be connected to the XBar 870 via the hub 830.

The tasks are managed by the scheduler unit 820 and dispatched to a GPC 850 by the work distribution unit 825. The GPC 850 is configured to process the task and generate results. The results may be consumed by other tasks within the GPC 850, routed to a different GPC 850 via the XBar 870, or stored in the memory 804. The results can be written to the memory 804 via the partition units 880, which implement a memory interface for reading and writing data to/from the memory 804. The results can be transmitted to another PPU 804 or CPU via the NVLink 810. In an embodiment, the PPU 800 includes a number U of partition units 880 that is equal to the number of separate and distinct memory devices 804 coupled to the PPU 800. A partition unit 880 will be described in more detail below in conjunction with FIG. 9B.

In an embodiment, a host processor executes a driver kernel that implements an application programming interface (API) that enables one or more applications executing on the host processor to schedule operations for execution on the PPU 800. In an embodiment, multiple compute applications are simultaneously executed by the PPU 800 and the PPU 800 provides isolation, quality of service (QOS), and independent address spaces for the multiple compute applications. An application may generate instructions (e.g., API calls) that cause the driver kernel to generate one or more tasks for execution by the PPU 800. The driver kernel outputs tasks to one or more streams being processed by the PPU 800. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory (SMEM). Threads, cooperating threads and a hierarchical grouping of threads such as cooperating thread arrays (CTA) and cooperating group arrays (CGA) according to some embodiments are described in more detail in U.S. application Ser. No. 17/691,621, the entire content of which is hereby incorporated by reference in its entirety. The SMEM, according to some embodiments, is described in U.S. application Ser. No. 17/691,690, which is hereby incorporated in reference in its entirety.

FIG. 9A illustrates a GPC 850 of the PPU 800 of FIG. 8, in accordance with an embodiment. As shown in FIG. 9A, each GPC 850 includes a number of hardware units for processing tasks. In an embodiment, each GPC 850 includes a pipeline manager 910, a pre-raster operations unit (PROP) 915, a raster engine 925, a work distribution crossbar (WDX) 980, a memory management unit (MMU) 990, and one or more Data Processing Clusters (DPCs) 920. It will be appreciated that the GPC 850 of FIG. 9A may include other hardware units in lieu of or in addition to the units shown in FIG. 9A.

In an embodiment, the operation of the GPC 850 is controlled by the pipeline manager 910. The pipeline manager 910 manages the configuration of the one or more DPCs 920 for processing tasks allocated to the GPC 850. In an embodiment, the pipeline manager 910 may configure at least one of the one or more DPCs 920 to implement at least a portion of a graphics rendering pipeline, a neural network, and/or a compute pipeline. For example, with respect to a graphics rendering pipeline, a DPC 920 may be configured to execute a vertex shader program on the programmable streaming multiprocessor (SM) 940. The pipeline manager 910 may also be configured to route packets received from the work distribution unit 825 to the appropriate logical units within the GPC 850. For example, some packets may be routed to fixed function hardware units in the PROP 915 and/or raster engine 925 while other packets may be routed to the DPCs 920 for processing by the primitive engine 935 or the SM 940.

The PROP unit 915 is configured to route data generated by the raster engine 925 and the DPCs 920 to a Raster Operations (ROP) unit, described in more detail in conjunction with FIG. 9B. The PROP unit 915 may also be configured to perform optimizations for color blending, organize pixel data, perform address translations, and the like.

Each DPC 920 included in the GPC 850 includes an M-Pipe Controller (MPC) 930, a primitive engine 935, and one or more SMs 940. The MPC 930 controls the operation of the DPC 920, routing packets received from the pipeline manager 910 to the appropriate units in the DPC 920. For example, packets associated with a vertex may be routed to the primitive engine 935, which is configured to fetch vertex attributes associated with the vertex from the memory 804. In contrast, packets associated with a shader program may be transmitted to the SM 940.

The SM 940 comprises a programmable streaming processor that is configured to process tasks represented by a number of threads. Each SM 940 is multi-threaded and configured to execute a plurality of threads (e.g., 32 threads) from a particular group of threads concurrently. In an embodiment, the SM 940 implements a SIMT (Single-Instruction, Multiple-Thread) architecture where each thread in a group of threads (e.g., a warp) is configured to process a different set of data based on the same set of instructions. All threads in the group of threads execute the same instructions. In another embodiment, the SM 940 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 940 is described in more detail below in conjunction with FIG. 10A. FIG. 10B conceptually illustrates four subpartitions 1091-1094 implemented in an SM such as the SM shown in FIG. 10A, according to some embodiments.

The MMU 990 provides an interface between the GPC 850 and the partition unit 880. The MMU 990 may provide translation of virtual addresses into physical addresses, memory protection, and arbitration of memory requests. In an embodiment, the MMU 990 provides one or more translation lookaside buffers (TLBs) for performing translation of virtual addresses into physical addresses in the memory 804.

FIG. 9B illustrates a memory partition unit 880 of the PPU 800 of FIG. 8 in accordance with an embodiment. As shown in FIG. 9B, the memory partition unit 880 includes a Raster Operations (ROP) unit 950, a level two (L2) cache 960, and a memory interface 970. The memory interface 970 is coupled to the memory 804. Memory interface 970 may implement 32, 64, 128, 1024-bit data buses, or the like, for high-speed data transfer. In an embodiment, the PPU 800 incorporates U memory interfaces 970, one memory interface 970 per pair of partition units 880, where each pair of partition units 880 is connected to a corresponding memory device 804. For example, PPU 800 may be connected to up to Y memory devices 804, such as high bandwidth memory stacks or graphics double-data-rate, version 5, synchronous dynamic random access memory, or other types of persistent storage.

In an embodiment, the memory interface 970 implements an HBM2 memory interface and Y equals half U. In an embodiment, the HBM2 memory stacks are located on the same physical package as the PPU 800, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 824 bits.

In an embodiment, the memory 804 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 800 process very large datasets and/or run applications for extended periods.

In an embodiment, the PPU 800 implements a multi-level memory hierarchy. In an embodiment, the memory partition unit 880 supports a unified memory to provide a single unified virtual address space for CPU and PPU 300 memory, enabling data sharing between virtual memory systems. In an embodiment the frequency of accesses by a PPU 800 to memory located on other processors is traced to ensure that memory pages are moved to the physical memory of the PPU 800 that is accessing the pages more frequently. In an embodiment, the NVLink 810 supports address translation services allowing the PPU 800 to directly access a CPU's page tables and providing full access to CPU memory by the PPU 800.

In an embodiment, copy engines transfer data between multiple PPUs 800 or between PPUs 800 and CPUs. The copy engines can generate page faults for addresses that are not mapped into the page tables. The memory partition unit 880 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 804 or other system memory may be fetched by the memory partition unit 880 and stored in the L2 cache 960, which is located on-chip and is shared between the various GPCs 850. As shown, each memory partition unit 880 includes a portion of the L2 cache 960 associated with a corresponding memory device 804. Lower level caches may then be implemented in various units within the GPCs 850. For example, each of the SMs 940 may implement a level one (L1) cache. The L1 cache is private memory that is dedicated to a particular SM 940. Data from the L2 cache 960 may be fetched and stored in each of the L1 caches for processing in the functional units of the SMs 940. The L2 cache 960 is coupled to the memory interface 970 and the XBar 870.

The ROP unit 950 performs graphics raster operations related to pixel color, such as color compression, pixel blending, and the like. The ROP unit 950 also implements depth testing in conjunction with the raster engine 925, receiving a depth for a sample location associated with a pixel fragment from the culling engine of the raster engine 925. The depth is tested against a corresponding depth in a depth buffer for a sample location associated with the fragment. If the fragment passes the depth test for the sample location, then the ROP unit 950 updates the depth buffer and transmits a result of the depth test to the raster engine 925. It will be appreciated that the number of partition units 880 may be different than the number of GPCs 850 and, therefore, each ROP unit 950 may be coupled to each of the GPCs 850. The ROP unit 950 tracks packets received from the different GPCs 850 and determines which GPC 850 that a result generated by the ROP unit 950 is routed to through the Xbar 870. Although the ROP unit 950 is included within the memory partition unit 880 in FIG. 9B, in other embodiment, the ROP unit 950 may be outside of the memory partition unit 880. For example, the ROP unit 950 may reside in the GPC 850 or another unit.

FIG. 10A illustrates the streaming multiprocessor 940 of FIG. 9A, in accordance with an embodiment. As shown in FIG. 10A, the SM 940 includes an instruction cache 1005, one or more scheduler units 1010, a register file 1020, one or more processing cores 1050, one or more special function units (SFUs) 1052, one or more load/store units (LSUs) 1054, an interconnect network 1080, a SMEM/L1 cache 1070.

As described above, the work distribution unit 825 dispatches tasks for execution on the GPCs 850 of the PPU 800. The tasks are allocated to a particular DPC 920 within a GPC 850 and, if the task is associated with a shader program, the task may be allocated to an SM 940. The scheduler unit 1010 receives the tasks from the work distribution unit 825 and manages instruction scheduling for one or more thread blocks assigned to the SM 940. The scheduler unit 1010 schedules thread blocks for execution as warps of parallel threads, where each thread block consists of at least one warp. In an embodiment, each warp comprises 32 threads. The scheduler unit 1010 may manage a plurality of different thread blocks, allocating the different thread blocks to different warps and then dispatching instructions from the plurality of different cooperative groups to the various functional units (e.g., cores 1050, SFUs 1052, and LSUs 1054) during each clock cycle.

Cooperative Group Arrays (CGAs) provide a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Group Arrays enable programmers to define groups of threads explicitly at sub-block (e.g., as small as a single thread) and multi-block granularities, and to perform collective operations on the threads such as synchronization in a cooperative group. The programming model supports clean composition across software boundaries, so that libraries and utility functions can synchronize safely within their local context without having to make assumptions about convergence. Cooperative Group Array primitives enable new patterns of cooperative parallelism, including producer-consumer parallelism, opportunistic parallelism, and global synchronization across an entire grid of thread blocks. Hierarchical grouping of threads such as cooperating thread arrays (CTA) and cooperating group arrays (CGA) according to some embodiments are described in more detail in U.S. application Ser. No. 17/691,621, the entire content of which is hereby incorporated by reference in its entirety.

A dispatch unit 1015 is configured to transmit instructions to one or more of the functional units. In the embodiment, the scheduler unit 1010 includes two dispatch units 1015 that enable two different instructions from the same warp to be dispatched during each clock cycle. In alternative embodiments, each scheduler unit 1010 may include a single dispatch unit 1015 or additional dispatch units 1015.

Each SM 940 includes a register file 1020 that provides a set of registers for the functional units of the SM 940. In an embodiment, the register file 1020 is divided between each of the functional units such that each functional unit is allocated a dedicated portion of the register file 1020. In another embodiment, the register file 1020 is divided between the different warps being executed by the SM 940. The register file 1020 provides temporary storage for operands connected to the data paths of the functional units.

Each SM 940 comprises multiple processing cores 1050. In an embodiment, the SM 940 includes a large number (e.g., 128, etc.) of distinct processing cores 1050. Each core 1050 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic.

Tensor cores are configured to perform matrix operations, and, in an embodiment, one or more tensor cores are included in the cores 1050. In particular, the tensor cores are configured to perform deep learning matrix arithmetic, such as convolution operations for neural network training and inferencing.

In some embodiments, transposition hardware is included in the processing cores 1050 or another functional unit (e.g., SFUs 1052 or LSUs 1054) and is configured to generate matrix data stored by diagonals and/or generate the original matrix and/or transposed matrix from the matrix data stored by diagonals. The transposition hardware may be provided inside of the SMEM 1070 to register file 1020 load path of the SM 940.

Each SM 940 also comprises multiple SFUs 1052 that perform special functions (e.g., attribute evaluation, reciprocal square root, and the like). In an embodiment, the SFUs 1052 may include a tree traversal unit (e.g., TTU 943) configured to traverse a hierarchical tree data structure. In an embodiment, the SFUs 1052 may include texture unit (e.g., Texture Unit 942) configured to perform texture map filtering operations. In an embodiment, the texture units are configured to load texture maps (e.g., a 2D array of texels) from the memory 1004 and sample the texture maps to produce sampled texture values for use in shader programs executed by the SM 940. In an embodiment, the texture maps are stored in the SMEM/L1 cache 970. The texture units implement texture operations such as filtering operations using mip-maps (e.g., texture maps of varying levels of detail). In an embodiment, each SM 940 includes two texture units.

Each SM 940 also comprises multiple LSUs 1054 that implement load and store operations between the SMEM/L1 cache 1070 and the register file 1020. Each SM 940 includes an interconnect network 1080 that connects each of the functional units to the register file 1020 and the LSU 1054 to the register file 1020, SMEM/L1 cache 1070. In an embodiment, the interconnect network 1080 is a crossbar that can be configured to connect any of the functional units to any of the registers in the register file 1020 and connect the LSUs 1054 to the register file 1020 and memory locations in SMEM/L1 cache 1070.

The SMEM/L1 cache 1070 is an array of on-chip memory that allows for data storage and communication between the SM 940 and the primitive engine 935 and between threads in the SM 940. In an embodiment, the SMEM/L1 cache 1070 comprises 128 KB of storage capacity and is in the path from the SM 940 to the partition unit 1080. The SMEM/L1 cache 1070 can be used to cache reads and writes. One or more of the SMEM/L1 cache 1070, L2 cache 960, and memory 1004 are backing stores.

Combining data cache and SMEM functionality into a single memory block provides the best overall performance for both types of memory accesses. The capacity is usable as a cache by programs that do not use SMEM. For example, if SMEM is configured to use half of the capacity, texture and load/store operations can use the remaining capacity. Integration within the SMEM/L1 cache 1070 enables the SMEM/L1 cache 1070 to function as a high-throughput conduit for streaming data while simultaneously providing high-bandwidth and low-latency access to frequently reused data.

In the context of this disclosure, an SM or “streaming multiprocessor” means a processor architected as described in U.S. Pat. No. 7,447,873 to Nordquist including improvements thereto and advancements thereof, and as implemented for example in many generations of NVIDIA GPUs. For example, an SM may comprise a plurality of processing engines or cores configured to concurrently execute a plurality of threads arranged in a plurality of single-instruction, multiple-data (SIMD) groups (e.g., warps), wherein each of the threads in a same one of the SIMD groups executes a same data processing program comprising a sequence of instructions on a different input object, and different threads in the same one of the SIMD group are executed using different ones of the processing engines or cores. An SM may typically also provide (a) a local register file having plural lanes, wherein each processing engine or core is configured to access a different subset of the lanes; and instruction issue logic configured to select one of the SIMD groups and to issue one of the instructions of the same data processing program to each of the plurality of processing engines in parallel, wherein each processing engine executes the same instruction in parallel with each other processing engine using the subset of the local register file lanes accessible thereto. An SM typically further includes core interface logic configured to initiate execution of one or more SIMD groups. As shown in the figures, such SMs have been constructed to provide fast local SMEM enabling data sharing/reuse and synchronization between all threads of a CTA executing on the SM.

When configured for general purpose parallel computation, a simpler configuration can be used compared with graphics processing. Specifically, the fixed function graphics processing units shown in FIG. 9A, are bypassed, creating a much simpler programming model. In the general purpose parallel computation configuration, the work distribution unit 1025 assigns and distributes blocks of threads directly to the DPCs 920. The threads in a block execute the same program, using a unique thread ID in the calculation to ensure each thread generates unique results, using the SM 940 to execute the program and perform calculations, SMEM/L1 cache 1070 to communicate between threads, and the LSU 1054 to read and write global memory through the SMEM/L1 cache 1070 and the memory partition unit 1080. When configured for general purpose parallel computation, the SM 940 can also write commands that the scheduler unit 1020 can use to launch new work on the DPCs 920.

The PPU 800 as described in this disclosure, may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 800 is embodied on a single semiconductor substrate. In another embodiment, the PPU 800 is included in a system-on-a-chip (SoC) along with one or more other devices such as additional PPUs 800, the memory 1004, a reduced instruction set computer (RISC) CPU, a memory management unit (MMU), a digital-to-analog converter (DAC), and the like.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 11A is a conceptual diagram of a processing system 1100 implemented using PPUs 800 that include two or more of the PPU 800 of FIG. 8, in accordance with an embodiment. The exemplary system 1100 may be configured to implement the methods disclosed in this application. The processing system 1100 includes a CPU 1130, switch 1155, and multiple PPUs each and respective memories 1004. The NVLink 1010 provides high-speed communication links between each of the PPUs. Although a particular number of NVLink 1010 and interconnect 1002 connections are illustrated in FIG. 11A, the number of connections to each PPU and the CPU 1130 may vary. The switch 1155 interfaces between the interconnect 1002 and the CPU 1130. The PPUs, memories 1004, and NVLinks 1010 may be situated on a single semiconductor platform to form a parallel processing module 1125. In an embodiment, the switch 1155 supports two or more protocols to interface between various different connections and/or links.

In another embodiment (not shown), the NVLink 1010 provides one or more high-speed communication links between each of the PPUs and the CPU 1130 and the switch 1155 interfaces between the interconnect 1002 and each of PPUs. The PPUs, memories 1004, and interconnect 1002 may be situated on a single semiconductor platform to form a parallel processing module 1125. In yet another embodiment (not shown), the interconnect 1002 provides one or more communication links between each of the PPUs and the CPU 1130 and the switch 1155 interfaces between each of the PPUs using the NVLink 1010 to provide one or more high-speed communication links between the PPUs. In another embodiment (not shown), the NVLink 1010 provides one or more high-speed communication links between the PPUs and the CPU 1130 through the switch 1155. In yet another embodiment (not shown), the interconnect 1002 provides one or more communication links between each of the PPUs directly. One or more of the NVLink 1010 high-speed communication links may be implemented as a physical NVLink interconnect or either an on-chip or on-die interconnect using the same protocol as the NVLink 1010.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1125 may be implemented as a circuit board substrate and each of the PPUs 800 and/or memories 1004 may be packaged devices. In an embodiment, the CPU 1130, switch 1155, and the parallel processing module 1125 are situated on a single semiconductor platform.

In an embodiment, the NVLink 1010 allows direct load/store/atomic access from the CPU 1130 to each PPU's 800 memory 1004. In an embodiment, the NVLink 1010 supports coherency operations, allowing data read from the memories 1004 to be stored in the cache hierarchy of the CPU 1130, reducing cache access latency for the CPU 1130. In an embodiment, the NVLink 1010 includes support for Address Translation Services (ATS), allowing the PPU 800 to directly access page tables within the CPU 1130. One or more of the NVLinks 1010 may also be configured to operate in a low-power mode.

FIG. 11B illustrates an exemplary system 1165 in which the various architecture and/or functionality of the various previous embodiments may be implemented. The exemplary system 1165 may be configured to implement the methods disclosed in this application.

As shown, a system 1165 is provided including at least one central processing unit 1130 that is connected to a communication bus 1175. The communication bus 1175 may be implemented using any suitable protocol, such as PCI (Peripheral Component Interconnect), PCI-Express, AGP (Accelerated Graphics Port), HyperTransport, or any other bus or point-to-point communication protocol(s). The system 1165 also includes a main memory 1140. Control logic (software) and data are stored in the main memory 1140 which may take the form of random access memory (RAM).

The system 1165 also includes input devices 1160, the parallel processing system 1125, and display devices 1145, e.g. a conventional CRT (cathode ray tube), LCD (liquid crystal display), LED (light emitting diode), plasma display or the like. User input may be received from the input devices 1160, e.g., keyboard, mouse, touchpad, microphone, and the like. Each of the foregoing modules and/or devices may even be situated on a single semiconductor platform to form the system 1165. Alternately, the various modules may also be situated separately or in various combinations of semiconductor platforms per the desires of the user.

Further, the system 1165 may be coupled to a network (e.g., a telecommunications network, local area network (LAN), wireless network, wide area network (WAN) such as the Internet, peer-to-peer network, cable network, or the like) through a network interface 1135 for communication purposes.

The system 1165 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1140 and/or the secondary storage. Such computer programs, when executed, enable the system 1165 to perform various functions. The memory 1140, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1165 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

An application program may be implemented via an application executed by a host processor, such as a CPU. In an embodiment, a device driver may implement an application programming interface (API) that defines various functions that can be utilized by the application program in order to generate graphical data for display. The device driver is a software program that includes a plurality of instructions that control the operation of the PPU 800 comprising 2 or more PPU 800. The API provides an abstraction for a programmer that lets a programmer utilize specialized graphics hardware, such as the PPU 800, to generate the graphical data without requiring the programmer to utilize the specific instruction set for the PPU 800. The application may include an API call that is routed to the device driver for the PPU. The device driver interprets the API call and performs various operations to respond to the API call. In some instances, the device driver may perform operations by executing instructions on the CPU. In other instances, the device driver may perform operations, at least in part, by launching operations on the PPU 800 utilizing an input/output interface between the CPU and the PPU. In an embodiment, the device driver is configured to implement the graphics processing pipeline utilizing the hardware of the PPU 800.

Various programs may be executed within the PPU 800 comprising 2 or more PPU 800 in order to implement the various stages of the processing for the application program. For example, the device driver may launch a kernel on the PPU 800 to perform one stage of processing on one SM 940 (or multiple SMs 940). The device driver (or the initial kernel executed by PPU 800) may also launch other kernels on the PPU 800 to perform other stages of the processing. If the application program processing includes a graphics processing pipeline, then some of the stages of the graphics processing pipeline may be implemented on fixed unit hardware such as a rasterizer or a data assembler implemented within the PPU 800. It will be appreciated that results from one kernel may be processed by one or more intervening fixed function hardware units before being processed by a subsequent kernel on an SM 940.

The techniques disclosed herein may be incorporated in any processor that may be used for processing a neural network such as, for example, a central processing unit (CPU), a graphics processing unit (GPU), an intelligence processing unit (IPU), neural processing unit (NPU), tensor processing unit (TPU), neural network processor (NNP), a data processing unit (DPU), a vision processing unit (VPU), an application specific integrated circuit (ASIC), a field-programmable gate array (FPGA), and the like. Such a processor may be incorporated in a personal computer (e.g., a laptop), at a data center, in an Internet of Things (IoT) device, a handheld device (e.g., smartphone), a vehicle, a robot, or any other device that performs inference, training or any other processing of a neural network. Such a processor may be employed in a virtualized system such that an operating system executing in a virtual machine on the system can utilize the processor.

As an example, a processor incorporating the techniques disclosed herein can be employed to process one or more neural networks in a machine to identify, classify, manipulate, handle, operate, modify, or navigate around physical objects in the real world. For example, such a processor may be employed in an autonomous vehicle (e.g., an automobile, motorcycle, helicopter, drone, plane, boat, submarine, delivery robot, etc.) to move the vehicle through the real world. Additionally, such a processor may be employed in a robot at a factory to select components and assemble components into an assembly.

As an example, a processor incorporating the techniques disclosed herein can be employed to process one or more neural networks to identify one or more features in an image or to alter, generate, or compress an image. For example, such a processor may be employed to enhance an image that is rendered using raster, ray-tracing (e.g., using NVIDIA RTX), and/or other rendering techniques. In another example, such a processor may be employed to reduce the amount of image data that is transmitted over a network (e.g., the Internet, a mobile telecommunications network, a WIFI network, as well as any other wired or wireless networking system) from a rendering device to a display device. Such transmissions may be utilized to stream image data from a server or a data center in the cloud to a user device (e.g., a personal computer, video game console, smartphone, other mobile device, etc.) to enhance services that stream images such as NVIDIA Geforce Now (GFN), Google Stadia, and the like.

As an example, a processor incorporating the techniques disclosed herein can be employed to process one or more neural networks for any other types of applications that can take advantage of a neural network. For example, such applications may involve translating from one spoken language to another, identifying and negating sounds in audio, detecting anomalies or defects during production of goods and services, surveillance of living and/or non-living things, medical diagnosis, decision making, and the like.

As an example, a processor incorporating the techniques disclosed herein can be employed to implement neural networks such as large language models (LLMs) to generate content (e.g., images, video, text, essays, audio, and the like), respond to user queries, solve problems in mathematical and other domains, and the like.

All patents, patent applications and publications cited herein are incorporated by reference for all purposes as if expressly set forth.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A computer system, comprising:
a matrix multiply and add (MMA) circuit configured to calculate a product of an A matrix and a B matrix based on operands of the A and B matrices and scale metadata associated with the operands; and
a device memory, connected to the MMA circuit, and storing a plurality of scale metadata block data structures, each scale metadata block data structure comprising s scale factors for a respective area defined by p rows and q columns in the A matrix or q rows and p columns in the B matrix, wherein q is determined based on a first vector length, s, p and a scale factor allocation associated with the first vector length,
wherein the scale metadata comprises the s scale factors.

2. The computer system according to claim 1, wherein the first vector length is determined in accordance with a data path of the MMA circuit.

3. The computer system according to claim 1, wherein the operands include narrow operands.

4. The computer system according to claim 1, wherein the scale factor allocation comprises a first number of scale factors.

5. The computer system according to claim 4, wherein the first number is determined according to one of a first layout that specifies 1 as the first number, a second layout that specifies 2 as the first number, or a third layout that specifies 4 as the first number.

6. The computer system according to claim 1, wherein q=d*s/(p*r), wherein d is the first vector length and r is the scale factor allocation.

7. The computer system according to claim 6, wherein s=512, p=128, the first vector length is determined in accordance with the data path of the MMA circuitry, and said r is determined based on the first vector length and according to one of a first layout that specifies 1 as the first number, a second layout that specifies 2 as the first number, or a third layout that specifies 4 as the first number.

8. The computer system according to claim 1, wherein each of the s scale factors is 1 byte.

9. The computer system according to claim 8, wherein, for each scale metadata block data structure in the plurality of scale metadata block data structures, values of said s, said p, said first vector length and said scale factor allocation are same as other scale metadata block data structures in the plurality of scale metadata block data structures.

10. The computer system according to claim 1, wherein the device memory further storing a second plurality of scale metadata block data structures, each scale metadata block data structure in the second plurality of scale metadata block data structures comprising s scale factors for the respective area defined by p rows and q columns in the A matrix or q rows and p columns in the B matrix, and wherein the scale metadata further comprises the s scale factors from a scale metadata block data structure of the second plurality of scale metadata block data structures.

11. The computer system according to claim 1, further comprising a global memory having stored therein an instance of the plurality of scale metadata block data structures.

12. The computer system according to claim 1, further comprising a shared memory having stored therein another instance of the plurality of scale metadata block data structures,
wherein said another instance of the plurality of scale metadata block data structures is copied from the global memory to the shared memory, and the plurality of scale metadata block data structures is copied from the shared memory to the device memory.

13. The computer system according to claim 1, wherein, in said each scale metadata block data structure, the s scale factors for the respective area is arranged such that scale factors corresponding to one column of the A matrix are interleaved with scale factors of one or more other columns of the A matrix, or scale factors corresponding to one row of the B matrix are interleaved with scale factors of one or more other rows of the B matrix.

14. The computer system according to claim 13, wherein the interleaving comprises arranging scale factors of the one or more other columns of the A matrix in between scale factors corresponding to a first set of consecutive rows in the one column of the A matrix and scale factors corresponding to a second set of consecutive rows in the one column of the A matrix, or arranging scale factors of the one or more other rows of the B matrix in between scale factors corresponding to a first set of consecutive columns in the one row of the B matrix and scale factors corresponding to a second set of consecutive columns in the one row of the B matrix.

15. The computer system according to claim 13, wherein the one or more other columns of the A matrix comprises r−1 of the other columns, or the one or more other rows of the B matrix comprises r−1 other rows, wherein r is the scale factor allocation.

16. The computer system according to claim 1, wherein the plurality of scale metadata block data structures is logically arranged as an m×n array of scale factors, and at least one of the scale factors in the m×n array corresponds to a different number of said operands of the A matrix or the B matrix than others of the scale factors in the m×n array.

17. A method to calculate a product of an A matrix and a B matrix based on operands of the A and B matrices and scale metadata associated with the operands comprising:
storing in a global memory of a computer system, scale metadata block data structures, each scale metadata block data structure comprising s scale factors for a respective area defined by p rows and q columns in the A matrix or q rows and p columns in the B matrix, wherein q is determined based on a first vector length, s, p and a scale factor allocation associated with the first vector length;
copying from the global memory to a device memory, of a matrix multiply and add (MMA) circuit in the computer system, a plurality of the scale metadata block data structures; and
calculating the product in the MMA circuit, wherein the scale metadata associated with the operands includes the plurality of the scale metadata block data structures read from the device memory.

18. A non-transitory computer readable storage medium storing instructions that, when executed by a computer system, causes the computer system to perform operations comprising:
storing in a global memory of the computer system, scale metadata block data structures, each scale metadata block data structure comprising s scale factors for a respective area defined by p rows and q columns in the A matrix or q rows and p columns in the B matrix, wherein q is determined based on a first vector length, s, p and a scale factor allocation associated with the first vector length;
copying from the global memory to a device memory, of a matrix multiply and add (MMA) circuit in the computer system, a plurality of the scale metadata block data structures; and
calculating the product in the MMA circuit, wherein the scale metadata associated with the operands includes the plurality of the scale metadata block data structures read from the device memory.
